(19) United States
(12) Patent Application Publication
(10) Pub. No.: US 2026/0323570 A1
(43) Pub. Date: Oct. 15, 2026

(54) RESOURCE SCHEDULING AND PROCESSING FOR SIDELINK POSITIONING

(71) Applicant: Lenovo (Singapore) Pte. Ltd., Singapore (SG)

(72) Inventors: Robin Rajan Thomas, Bad Nauheim (DE); Karthikeyan Ganesan, Nauheim (DE); Abir Ben Hadj Fredj, Frankfurt am main (DE)

(21) Appl. No.: 19/111,988

(22) PCT Filed: Sep. 26, 2023
(86) PCT No.: PCT/IB2023/059562

§ 371 Date: Mar. 14, 2025

Related U.S. Application Data
(60) Provisional application No. 63/377,191, filed on Sep. 26, 2022.

(51) Int. Cl. H04W 64/00; H04L 5/00; H04W 76/27

(52) U.S. Cl. CPC H04W 64/00; H04L 5/0005; H04W 76/27

(57) ABSTRACT

Various aspects of the present disclosure relate to resource scheduling for a SL positioning group. A UE may be configured to schedule, to each member of a SL positioning group, a set of SL positioning time-frequency resources of a plurality of SL positioning time-frequency resources and to configure each member of the SL positioning group with a particular set of SL positioning time-frequency resources. The UE may be configured to transmit, to a SL positioning group member, an activation command for transmission of at least one SL PRS using a respective scheduled set of SL positioning time-frequency resources and to transmit, to the SL positioning group member, a deactivation command to release the respective scheduled set of SL positioning time-frequency resources.

### TECHNICAL FIELD

The present disclosure relates to wireless communications, and more specifically to resource scheduling and processing enhancements for a group of devices performing sidelink (SL) positioning.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

SL communication refers to peer-to-peer communication directly between UEs. Accordingly, the UEs communicate with one another without the communications being relayed via the mobile network (i.e., without the need of a base station).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the methods and apparatuses described herein may include a UE (e.g., a configuration UE) scheduling, to each member of a SL positioning group, a set of SL positioning time-frequency resources of a plurality of SL positioning time-frequency resources and configuring each member of the SL positioning group with a particular set of SL positioning time-frequency resources. The methods and apparatuses described herein may further include the configuration UE transmitting, to a SL positioning group member, an activation command for transmission of at least one SL positioning reference signal (“PRS”) using a respective scheduled set of SL positioning time-frequency resources and transmitting, to the SL positioning group member, a deactivation command to release the respective scheduled set of SL positioning time-frequency resources.

Some implementations of the methods and apparatuses described herein may further include a UE (e.g., a member UE) receiving, from a configuration device, a positioning configuration that schedules a set of SL positioning time-frequency resources of a plurality of SL positioning time-frequency resources and receiving, from the configuration device, an activation command for the scheduled set of SL positioning time-frequency resources. The methods and apparatuses described herein may further include the member UE performing a SL positioning procedure using the scheduled set of SL positioning time-frequency resources and receiving, from the configuration device, a deactivation command to release the respective scheduled set of SL positioning time-frequency resources, where the SL positioning procedure includes transmitting a SL PRS, measuring a SL PRS transmission, reporting a SL positioning measurement, or a combination thereof.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of a SL protocol stack showing different protocol layers in a pair of UEs, in accordance with aspects of the present disclosure.

FIG. 4 illustrates an example of a timing diagram for a Multi-cell Round Trip Time (Multi-RTT) measurement procedure, in accordance with aspects of the present disclosure.

FIG. 5 illustrates an example of a range estimation using a single unit Round Trip Time (RTT) positioning framework, in accordance with aspects of the present disclosure.

FIG. 6A illustrates an example of a relative positioning, variable coordinate system, in accordance with aspects of the present disclosure.

FIG. 6B illustrates an example of a relative positioning, variable and moving coordinate system, in accordance with aspects of the present disclosure.

FIG. 6C illustrates an example of an absolute positioning, fixed coordinate system, in accordance with aspects of the present disclosure.

FIG. 7 illustrates an example of a beam-based positioning framework, in accordance with aspects of the present disclosure.

FIG. 8 illustrates an example of an Abstract Syntax Notation 1 (ASN.1) structure of a RequestLocationInformation message body, in accordance with aspects of the present disclosure.

FIG. 9 illustrates an example of an ASN.1 structure of a ProvideLocationInformation message body, in accordance with aspects of the present disclosure.

FIG. 10 illustrates an example of a SL positioning resource profile, in accordance with aspects of the present disclosure.

FIG. 11 illustrates an example of a procedure for SL positioning group resource request/response, in accordance with aspects of the present disclosure.

FIG. 12 illustrates an example of a procedure for SL positioning group resource scheduling and activation/deactivation, in accordance with aspects of the present disclosure.

FIG. 13 illustrates an example of a user equipment (UE) 1300, in accordance with aspects of the present disclosure.

FIG. 14 illustrates an example of a processor 1400, in accordance with aspects of the present disclosure.

FIG. 15 illustrates an example of a network equipment (NE) 1500, in accordance with aspects of the present disclosure.

FIG. 16 illustrates a flowchart of a method performed by a configuration UE in accordance with aspects of the present disclosure.

FIG. 17 illustrates a flowchart of a method performed by a member UE in accordance with aspects of the present disclosure.

### DETAILED DESCRIPTION

Generally, the present disclosure describes systems, methods, and apparatuses for resource scheduling enhancements for a SL positioning group. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In Third Generation Partnership Project (3GPP) Release 16 (Rel-16) and Release 17 (Rel-17), a Uu interface positioning framework is defined which enables UE-assisted and UE-based positioning methods. As used herein “Uu” refers to the wireless link/interface between a UE and abase station unit, such as gNB. However, the Rel-16 and Rel-17 positioning frameworks lack an efficient UE-to-UE range and/or orientation determination, which is essential to support relative positioning applications across different vertical services, e.g., Vehicle-to-everything (V2X), public safety, Industrial IoT (IIoT), Commercial, etc. Thus, SL positioning techniques are to be developed, including various Layer-1 (L1) and Layer-2 (L2) procedures to support absolute and/or relative positioning—including range estimation—using SL resources.

The use cases of SL Positioning are meant to enable SL positioning in all coverage scenarios, e.g., in-coverage, partial coverage, and out-of-coverage. Due to the involvement and coordination of multiple UEs in SL positioning, it is essential that the resources for each of the participating UEs/devices are managed in a manner that is not detrimental to the positioning performance (e.g., interference) and reduces signaling overhead. The current Mode-1 and Mode-2 resource allocation procedures need to be enhanced to cater for multiple UEs being involved in a single SL positioning session. In Rel-16, Mode-2(d) resource allocation procedures for SL data transmission were studied but not specified, where it was supported for UE-A to inform its serving gNB about members UE-B, UE-C, and so on of a group, and for the gNB to provide individual resource pool configurations and/or individual resource configurations to each group member through UE-A. However, Mode-2(d) was limited in that UE-A could not modify the configurations and the overall design was meant for SL Data transmissions and not SL positioning procedures, e.g., SL-PRS transmissions, which require the multiple UEs to be involved in a SL positioning session.

As used herein, a “resource pool” refers to a set of resources assigned for sidelink operation. A resource pool consists of a set of resource blocks (i.e., Physical Resource Blocks (PRB)) over one or more time units (e.g., Orthogonal Frequency Division Multiplexing (OFDM) symbols, subframes, slots, subslots, etc.). In some embodiments, the set of resource blocks comprises contiguous PRBs in the frequency domain. A PRB, as used herein, consists of twelve consecutive subcarriers in the frequency domain. In certain embodiments, a UE may be configured with separate transmission resource pools (Tx RPs) and reception resource pools (Rx RPs), where the Tx RP of one UE is associated with an Rx RP of another UE to enable sidelink communication.

This disclosure presents systems, apparatuses, and methods for enhanced resource allocation methods for UEs/devices within a SL positioning group and aim to address one or more of the following key issues: Resource request by the configuration member UE/device on behalf of multiple member UEs/devices (including itself) within a group performing SL positioning; Resource scheduling, processing, and transfer of the given set of resources to all SL positioning group members; and Transmission of additional resources via the configuration member UE/device.

Disclosed herein are different ways to request and allocate resources for SL positioning procedures involving a SL positioning group. The present disclosure aims to solve one aspect of the coordinated resource allocation procedure via detailed solutions on the trigger, request, and response of the SL positioning group resource. The SL positioning Group resource request may be transmitted to a central configuration entity, e.g., gNB or Location Management Function (LMF) based on a host of criteria including SL positioning QoS and type of SL positioning technique. Thereafter, the central configuration entity may respond with the total resource allocation for the SL positioning group based on the type of SL positioning techniques, number of UEs involved and availability of resources.

In a first aspect of the disclosure, a configuration UE (or other configuration device/node) may request time-frequency SL positioning resources on behalf of members within a SL positioning group from another network entity, e.g., gNB, LMF or Road Side Unit (RSU) based on a received trigger and SL Positioning/ranging QoS.

In a second aspect of the disclosure, a network entity may provide a suitable response to the configuration UE (or configuration node or configuration device) in response to the received SL positioning request based on the type of SL positioning method, number of SL positioning UE/devices involved and availability of SL positioning resources.

Also disclosed herein are methods for a configuration UE (or other configuration device/node) to schedule and allocate resources for a variety of SL positioning procedures including SL Positioning Reference Signal (PRS) transmission and measurement reporting based on certain conditions and criteria. The resources are allocated to each SL positioning group member based on the reception of a totality of resources provided by a central configuration entity, e.g., gNB, LMF, RSU, or another configuration UE. In addition, methods are presented to enable member UEs to request for re-allocation or additional resources in the event of any dynamic changes to the SL positioning procedures, e.g., change of SL Positioning QoS, utilization of another positioning technique, etc.

In a third aspect of the disclosure, a method to schedule, process, and transfer time-frequency SL positioning resources to other members within a SL positioning group is detailed including the different resources to be scheduled based on the type of SL PRS configuration.

In a fourth aspect of the disclosure, a method to request for additional resources, resource re-allocations and associated configuration updates, which may be triggered by individual SL positioning group members or by the configuration UE (or other configuration device/node) based on the fulfilment of certain SL positioning conditions is described.

In a fifth aspect of the disclosure, a method for the member UEs to perform sensing, reservation and selection of the one or more subset of resources received by the configuration UE (or other configuration device/node).

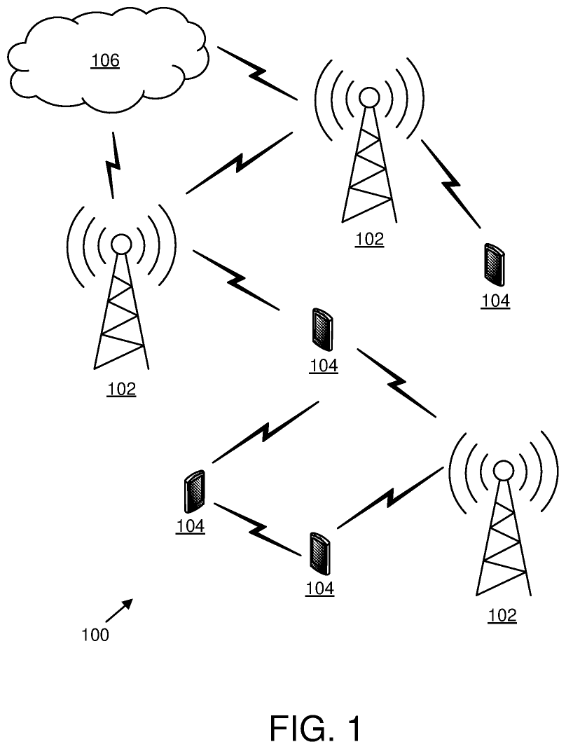

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

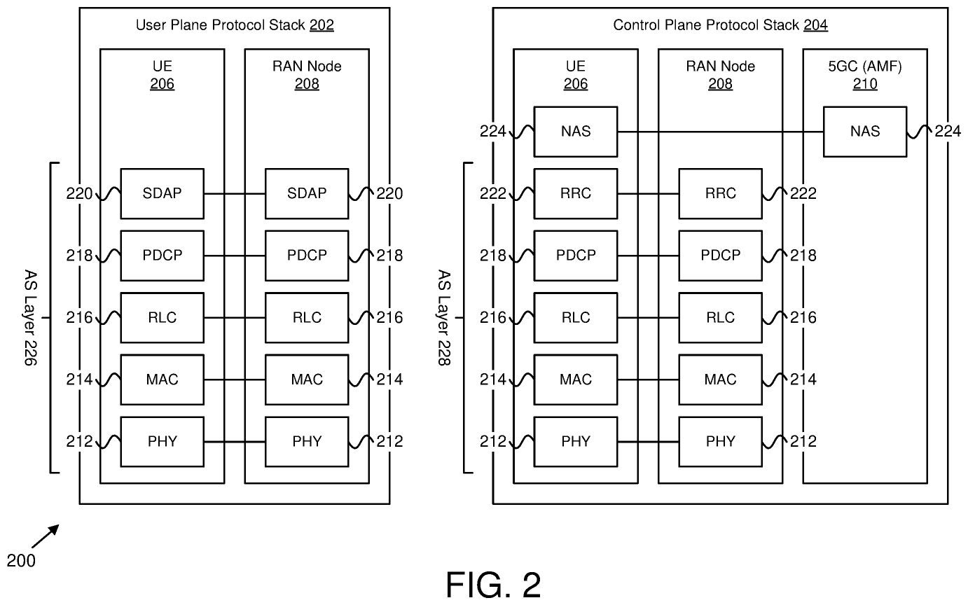

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP layer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in Multiple-Input Multiple-Output (MIMO) communication (also referred to as a “MIMO layer” or a “data stream”).

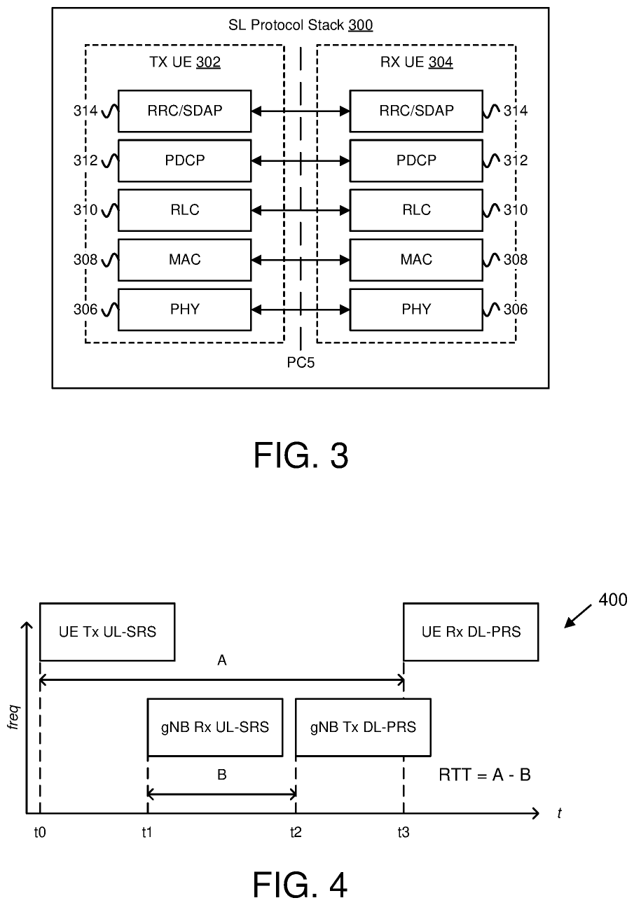

FIG. 3 depicts a SL protocol stack 300, according to embodiments of the disclosure. While FIG. 3 shows a transmitting SL UE 302 (denoted “TX UE”) and a receiving SL UE 304 (denoted “RX UE”), these are representative of a set of UEs communicating peer-to-peer via a PC5 interface, and other embodiments may involve different UEs. As depicted, the SL protocol stack 300 includes a physical layer 306, a MAC sublayer 308, a RLC sublayer 310, a PDCP sublayer 312, and RRC and SDAP layers (depicted as combined element “RRC/SDAP” 314), for the control plane and user plane, respectively. The physical layer 306, the MAC sublayer 308, the RLC sublayer 310, the PDCP sublayer 312, and the RRC/SDAP layers 314 may perform substantially the same functions described above with reference to the NR protocol stack 200, but supporting UE-to-UE communications between the TX UE 302 and the RX UE 304.

The AS protocol stack for the control plane in the SL protocol stack 300 consists of at least RRC, PDCP, RLC and MAC sublayers, and the physical layer. The AS protocol stack for the user plane in the SL protocol stack 300 consists of at least SDAP, PDCP, RLC and MAC sublayers, and the physical layer. The L2 is split into the SDAP, PDCP, RLC and MAC sublayers. The L3 includes the RRC sublayer for the control plane and includes, e.g., an IP layer for the user plane. L1 and L2 are referred to as “lower layers”, while L3 and above (e.g., transport layer, V2X layer, application layer) are referred to as “higher layers” or “upper layers.”

Regarding positioning performance requirements and positioning methods, for Rel-17, the different positioning requirements are especially stringent with respect to accuracy, latency, and reliability.

The supported positioning techniques in Rel-16 are listed in Table 1, below. These techniques are defined in 3GPP Technical Specification (TS) 38.306.

TABLE 1
Supported Rel-16 UE positioning methods

| | | UE-assisted, | NG-RAN node | Secure User-Plane Location |
|---|---|---|---|---|
| Method | UE-based | LMF-based | assisted | (SUPL) |
| A-GNSS | Yes | Yes | No | Yes (UE-based and UE-assisted) |
| OTDOA ^{Note1, Note 2} | No | Yes | No | Yes (UE-assisted) |
| E-CID ^{Note 3} | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS ^{Note 4} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | — | No |
| UL-TDOA | No | No | Yes | No |
| UL-AoA | No | No | Yes | No |

^{Note1}:
This includes Terrestrial Beacon System (TBS) positioning based on PRS signals.
^{Note 2}:
In this version of the specification only Observed Time Difference of Arrival (OTDOA) based on LTE signals is supported.
^{Note 3}:
This includes Cell-ID for NR method.
^{Note 4}:
In this version of the specification only for TBS positioning based on Metropolitan Beacon System (MBS) signals.

Separate positioning techniques as indicated in Table 1 can be currently configured and performed based on the requirements of the Location Management Function (LMF) and user Equipment (UE) capabilities. The transmission of Positioning Reference Signals (PRS) enables the UE to perform UE positioning-related measurements to enable the computation of a UE's location estimate and are configured per Transmission Reception Point (TRP), where a TRP may transmit one or more beams.

The following RAT-dependent positioning techniques are supported in Rel-16: Downlink Time Difference of Arrival (DL-TDOA); Downlink Angle-of-Departure (DL-AoD); Multi-RTT; Enhanced Cell Identity (E-CID); Uplink Time Difference of Arrival (UL-TDOA); Uplink Angle-of-Arrival (UL-AoA).

The DL-TDOA positioning method makes use of the DL Reference Signal Time Difference (RSTD) (and optionally DL PRS Reference Signal Received Power (RSRP)) of downlink signals received from multiple Transmission Points (TPs), at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL-AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The Multi-RTT positioning method makes use of the UE Rx-Tx measurements and DL PRS RSRP of downlink signals received from multiple TRPs, measured by the UE and the measured gNB Rx-Tx measurements and UL Sounding Reference Signal RSRP (SRS-RSRP) at multiple TRPs of uplink signals transmitted from UE.

FIG. 4 depicts an exemplary Multi-RTT procedure 400. The UE measures the UE Rx-Tx measurements (and optionally DL PRS RSRP of the received signals) using assistance data received from the positioning server (e.g., LMF server), and the TRPs measure the gNB Rx-Tx measurements (and optionally UL SRS-RSRP of the received signals) using assistance data received from the positioning server. The measurements are used to determine the Round-Trip Time (RTT) at the positioning server which are used to estimate the location of the UE.

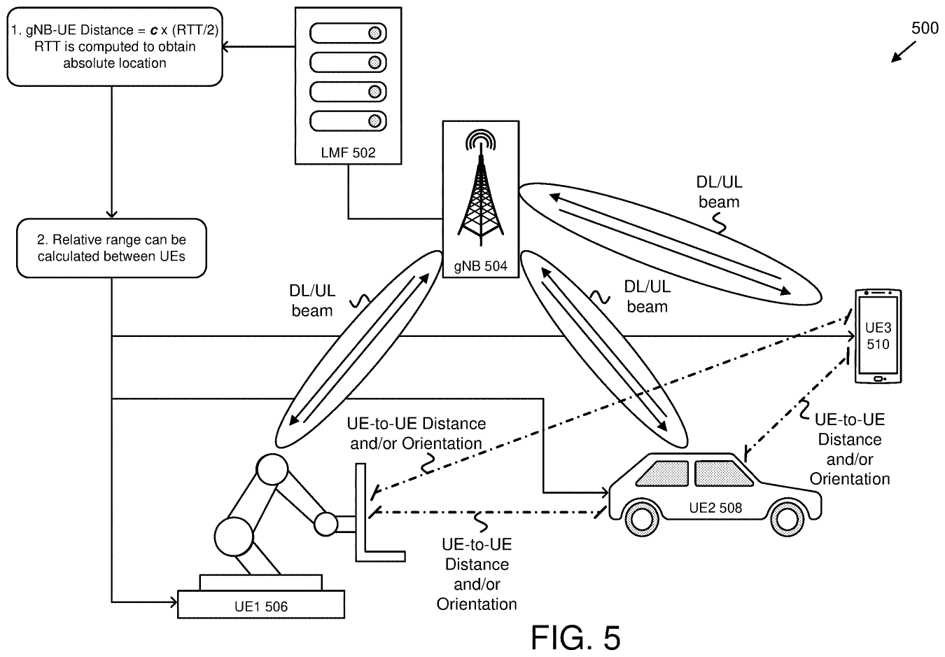

FIG. 5 depicts an example procedure 500 for relative range estimation using RTT positioning techniques. The procedure 500 involves a LMF server 502, a gNB 504, and a plurality of UEs, including a first UE 506 (denoted “UE1”), a second UE 508 (denoted “UE2”), and a third UE 510 (denoted “UE3”). The LMF server 502 may be one embodiment of the LMF 146, the gNB 504 may be one embodiment of the RAN node 208 and/or the NE 102, and the UEs may be embodiments of the UE 206, the TX UE 302 and/or RX UE 304.

At step 1, the gNB-UE distance is determined as half the gNB-UE RTT multiplied by the speed of light. The gNB-UE RTT is computed and used by the LMF server 502 to obtain an absolute location of a UE. Note that the LMF server 502 may use RTT measurements and beam orientation from a single gNB 504 to obtain the absolute UE location. In other embodiments, the LMF server 502 may use RTT measurements from multiple TRPs to obtain the absolute UE location.

At Step 2, the relative range (i.e., UE-to-UE distance) may be calculated between the UEs. Note that the relative UE-to-UE orientations may also be calculated. The UE1 506, UE2 508, and UE3 510 may determine UE-to-UE distances and orientations using the below described SL positioning techniques.

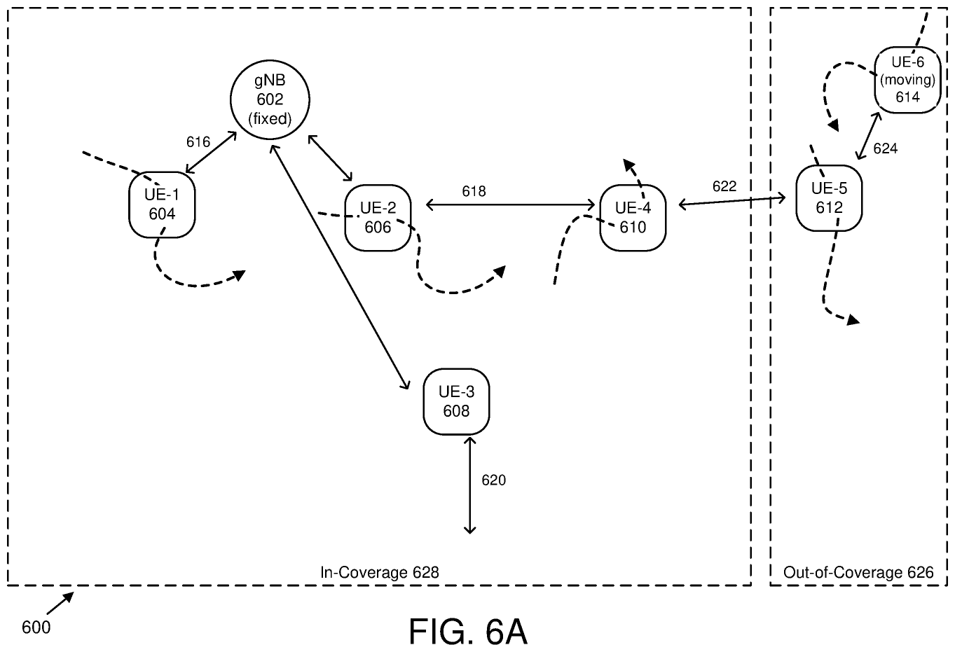

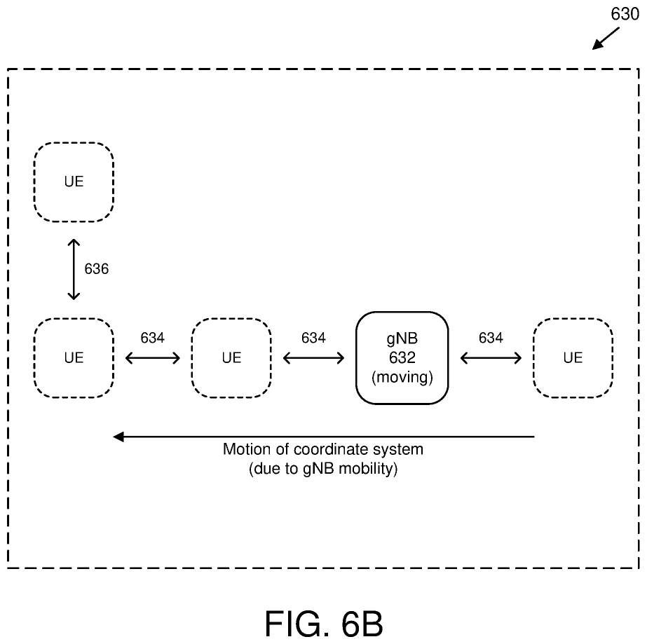

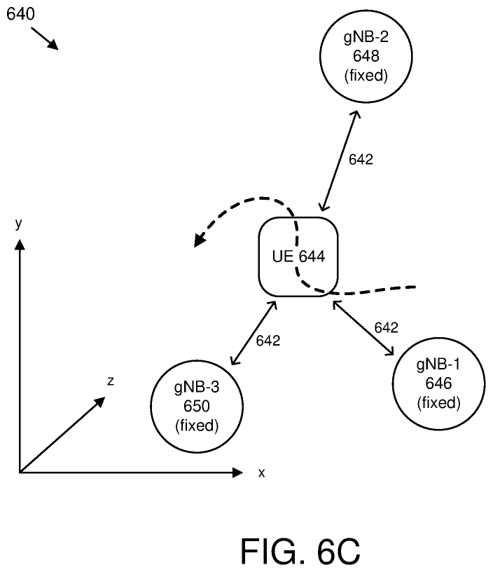

FIGS. 6A-6C depict an overview on absolute and relative positioning using different coordinate systems.

FIG. 6A depicts an example of relative positioning using a variable coordinate system 600. In some embodiments, the coordinate system 600 may be used to determine relative positioning 616 between a first UE (denoted “UE-1”) 604 and a 5G positioning node, such as the gNB 602 (having a fixed location), when the nodes are within 10 m of each other. In some embodiments, the coordinate system 600 may be used to determine relative positioning 618 between two or more UEs, such as the second UE (denoted “UE-2”) 606 and the fourth UE (denoted “UE-4”) 610, when the UEs are within 10 m of each other. In some embodiments, the coordinate system 600 may be used to determine vertical location 620 of a third UE (denoted “UE-3”) 608 in terms of relative height (or depth) to a local ground level. In some embodiments, the coordinate system 600 may be used to determine relative positioning 622 between a fifth UE (denoted “UE-5”) 612 that is out-of-coverage 626 of the network and one or more UEs that are within coverage 628 of the network (e.g., the UE-4), when the UEs are in proximity. Additionally, or alternatively, the coordinate system 600 may be used to determine relative positioning 624 of the UE-5 612 and a sixth UE (denoted “UE-6”) 614 that is also out-of-coverage 626 of the network. The depicted gNBs may be embodiments of the NE 102 and/or the RAN node 208, while the UEs may be embodiments of the UE 104, the UE 206, the TX UE 302 and/or the RX UE 304.

FIG. 6B depicts an example of relative positioning using a variable and moving coordinate system 630. In contrast to the system 600, in the system 630 the gNB 632 is moving, so the coordinate system also moves relative to a fixed ground location. In some embodiments, the coordinate system 630 may be used to determine the relative longitudinal positions 634 (e.g., with accuracy of less than 0.5 m error) for UEs supporting V2X application for platooning in proximity. In some embodiments, the coordinate system 630 may be used to determine the relative lateral position 636 (e.g., with accuracy of less than 0.1 m error) between UEs supporting V2X applications. The depicted gNB 632 may be one embodiment of the NE 102 and/or the RAN node 208, while the UEs may be embodiments of the UE 104 and/or UE 206.

FIG. 6C depicts an example of absolute positioning using a fixed coordinate system 640. In contrast to the systems 600 and 630, in the fixed coordinate system 640 there are multiple fixed gNBs. In some embodiments, the coordinate system 640 may be used to determine the absolute location 642 of the UE 644 using a first gNB 646, a second gNB 648 and a third gNB 650. In certain embodiments, the absolute location may be expressed using x, y, and z coordinates. The depicted gNBs may be embodiments of the NE 102 and/or the RAN node 208, while the UE may be one embodiment of the UE 104 and/or UE 206.

Referring again to RAT-dependent positioning techniques, in the E-CID positioning method, the position of a UE 206 is estimated with the knowledge of its serving ng-eNB, gNB and cell and is based on Uu (e.g., LTE) signals. The information about the serving ng-eNB, gNB and cell may be obtained by paging, registration, or other methods. The NR E-CID positioning method refers to techniques which use additional UE measurements and/or NR radio resource and other measurements to improve the UE location estimate using NR signals.

Although the NR E-CID positioning method may utilize some of the same measurements as the measurement control system in the RRC protocol, the UE 206 generally is not expected to make additional measurements for the sole purpose of positioning; i.e., the positioning procedures do not supply a measurement configuration or measurement control message, and the UE 206 reports the measurements that it has available rather than being required to take additional measurement actions.

The UL-TDOA positioning method makes use of the time difference of arrival (and optionally UL SRS-RSRP) at multiple Reception Points of uplink signals transmitted from UE 206. The Reception Points measure the UL TDOA (and optionally UL SRS-RSRP) of the received UL signals using assistance data received from the positioning server, and the resulting measurements are used along with other configuration information to estimate the location of the UE 206.

The UL-AoA positioning method makes use of the measured azimuth and the zenith of arrival at multiple Reception Points of uplink signals transmitted from UE 206. The Reception Points measure Azimuth Angle-of-Arrival (A-AoA) and/or Zenith Angle-of-Arrival (Z-AoA) of the received signals using assistance data received from the positioning server, and the resulting measurements are used along with other configuration information to estimate the location of the UE 206.

RAT-dependent positioning techniques involve the 3GPP RAT and core network entities to perform the position estimation of the UE 206, which are differentiated from RAT-independent positioning techniques which rely on Global Navigation Satellite System (GNSS), Inertial Measurement Unit (IMU) sensor, Wireless Local Area Network (WLAN) and Bluetooth technologies for performing target device (i.e., UE 206) positioning.

The following RAT-Independent positioning techniques are supported in Rel-16: Network-assisted GNSS, Barometric pressure sensor positioning, WLAN positioning, Bluetooth positioning, TBS positioning, Motion sensor positioning.

The network-assisted GNSS (Global Navigation Satellite System) methods make use of UEs 206 that are equipped with radio receivers capable of receiving GNSS signals. In 3GPP specifications the term GNSS encompasses both global and regional/augmentation navigation satellite systems.

Examples of global navigation satellite systems include Global Positioning System (GPS), Modernized GPS, Galileo, GLObal'naya NAvigatsionnaya Sputnikovaya Sistema (GLONASS), and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. In this concept, different GNSSs (e.g., GPS, Galileo, etc.) can be used separately or in combination to determine the location of a UE 206.

Regarding barometric pressure sensor positioning, the barometric pressure sensor method makes use of barometric sensors to determine the vertical component of the position of the UE 206. The UE 206 measures barometric pressure, optionally aided by assistance data, to calculate the vertical component of its location or to send measurements to the positioning server for position calculation. This method should be combined with other positioning methods to determine the 3D position of the UE 206.

Regarding WLAN positioning, the WLAN positioning method makes use of the WLAN measurements (e.g., WLAN Access Point (AP) identifiers and, optionally, signal strength or other measurements) and databases to determine the location of the UE 206. The UE 206 measures received signals from WLAN APs, optionally aided by assistance data, to send measurements to the positioning server for position calculation. Using the measurement results and a references database, the location of the UE 206 is calculated. Alternatively, the UE 206 makes use of WLAN measurements and optionally WLAN AP assistance data provided by the positioning server, to determine its location.

Regarding Bluetooth positioning, the Bluetooth positioning method makes use of Bluetooth measurements (beacon identifiers and optionally other measurements) to determine the location of the UE 206. The UE 206 measures received signals from Bluetooth beacons. Using the measurement results and a references database, the location of the UE 206 is calculated. The Bluetooth methods may be combined with other positioning methods (e.g., WLAN) to improve positioning accuracy of the UE 206.

A TBS consists of a network of ground-based transmitters, broadcasting signals only for positioning purposes. Regarding TBS positioning, the current type of TBS positioning signals are the Metropolitan Beacon System (MBS) signals and PRS. The UE 206 measures received TBS signals, optionally aided by assistance data, to calculate its location or to send measurements to the positioning server for position calculation.

Regarding IMU/motion sensor positioning, this method makes use of different sensors such as accelerometers, gyros, magnetometers, to calculate the displacement of the UE 206. The UE 206 estimates a relative displacement based upon a reference position and/or reference time. The UE 206 sends a report comprising the determined relative displacement which can be used to determine the absolute position. This method should be used with other positioning methods for hybrid positioning.

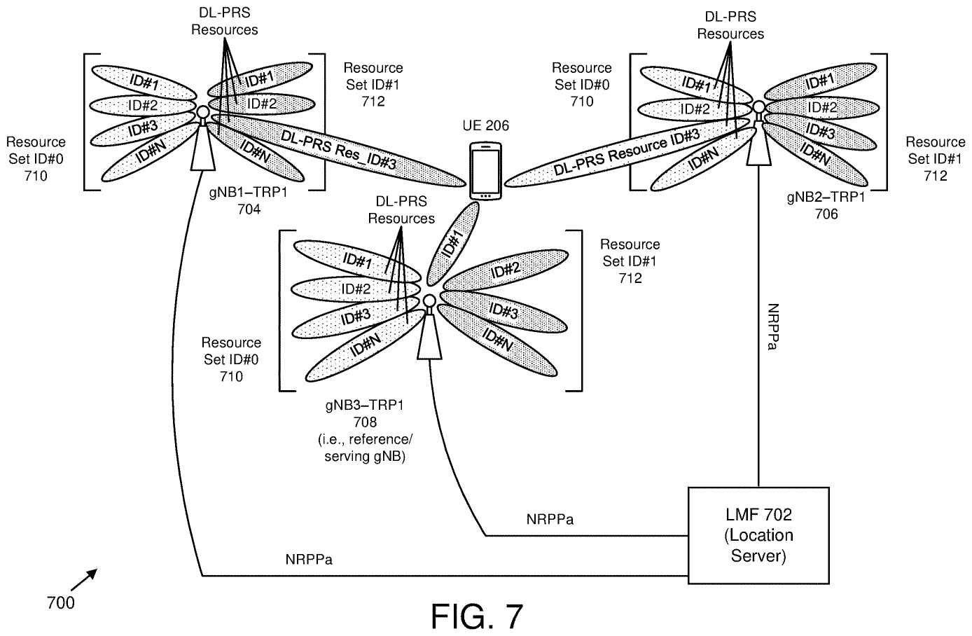

FIG. 7 shows a diagram 700 for NR beam-based positioning measurements and reference signals (RS), according to embodiments of the disclosure. Here, the downlink positioning reference signal (DL-PRS) can be transmitted by different base stations (serving gNB and neighboring gNB) using narrow beams over FR1 (i.e., frequencies from 410 MHz to 7125 MHz) and FR2 (i.e., frequencies from 24.25 GHz to 52.6 GHz), which is relatively different when compared to LTE where the PRS was transmitted across the whole cell. As illustrated in FIG. 7, a UE 206 may receive DL-PRS from a neighboring first gNB/TRP (denoted “gNB1-TRP1”) 704, from a neighboring second gNB (denoted “gNB2-TRP1”) 706, and also from a third gNB/TRP (denoted “gNB3-TRP1”) 708 which is a reference or serving gNB.

Here, the DL-PRS can be locally associated with a DL-PRS Resource Identifier (ID) and Resource Set ID for a base station (i.e., TRP). In the depicted embodiments, each gNB 704, 706, 708 is configured with a first Resource Set ID (depicted as “Resource Set ID #0”) 710 and a second Resource Set ID (depicted as “Resource Set ID #1”) 712. As depicted, the UE 206 receives DL-PRS on transmission beams; here, receiving DL-PRS from the gNB1-TRP1 704 on DL-PRS Resource ID #3 from the second Resource Set ID (Resource Set ID #1) 712, receiving DL-PRS from the gNB2-TRP1 706 on DL-PRS Resource ID #3 from the first Resource Set ID (Resource Set ID #0) 710, and receiving DL-PRS from the gNB3-TRP1 708 on DL-PRS Resource ID #1 from the second Resource Set ID (Resource Set ID #1) 712.

Similarly, UE positioning measurements such as Reference Signal Time Difference (RSTD) and PRS RSRP measurements are made between different beams (e.g., between a different pair of DL PRS resources or DL PRS resource sets)—as opposed to different cells as was the case in LTE. The LMF server 702 uses the UE positioning measurements to determine the UE's location (e.g., absolute location). In addition, there are additional UL positioning methods for the network to exploit in order to compute the target UE's location. Table 2 and Table 3 show the reference signal to measurements mapping required for each of the supported RAT-dependent positioning techniques at the UE and gNB, respectively.

TABLE 2
UE Measurements to enable RAT-dependent
positioning techniques

| | | To facilitate |
|---|---|---|
| | | support of the |
| | | following |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, |
| | | DL-AoD, |
| | | Multi-RTT |
| Rel. 16 DL PRS/Rel.16 | UE Rx − Tx time | Multi-RTT |
| SRS for positioning | difference | |
| Rel. 15 Synchronization | SS-RSRP (RSRP for RRM), | E-CID |
| Signal Block (SSB)/ | SS-RSRQ(for RRM), | |
| CSI-RS for Radio | CSI-RSRP (for RRM), | |
| Resource Management | CSI-RSRQ (for RRM), | |
| (RRM) | SS-RSRPB (for RRM) | |

TABLE 3
gNB Measurements to enable RAT-
dependent positioning techniques

| | | To facilitate support |
|---|---|---|
| | | of the following |
| DL/UL Reference | | positioning |
| Signals | gNB Measurements | techniques |
| Rel-16 SRS for | UL Relative Time | UL-TDOA |
| positioning | of Arrival (RTOA) | |
| Rel-16 SRS for | UL SRS-RSRP | UL-TDOA, UL-AoA, |
| positioning | | Multi-RTT |
| Rel-16 SRS for | gNB Rx − Tx time | Multi-RTT |
| positioning, | difference | |
| Rel-16 DL PRS | | |
| Rel-16 SRS for | A-AoA and Z-AoA | UL-AoA, |
| positioning, | | Multi-RTT |

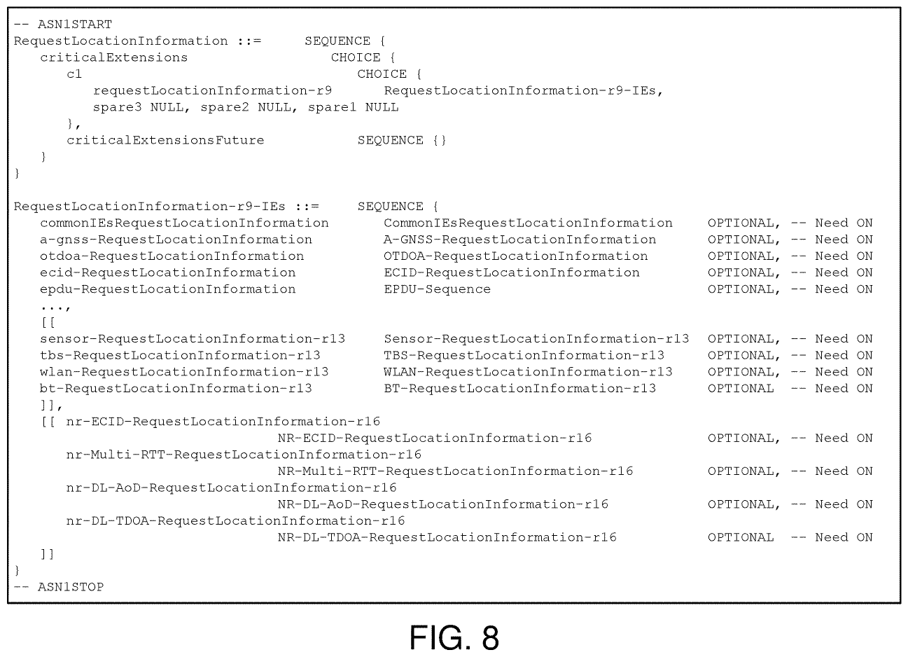

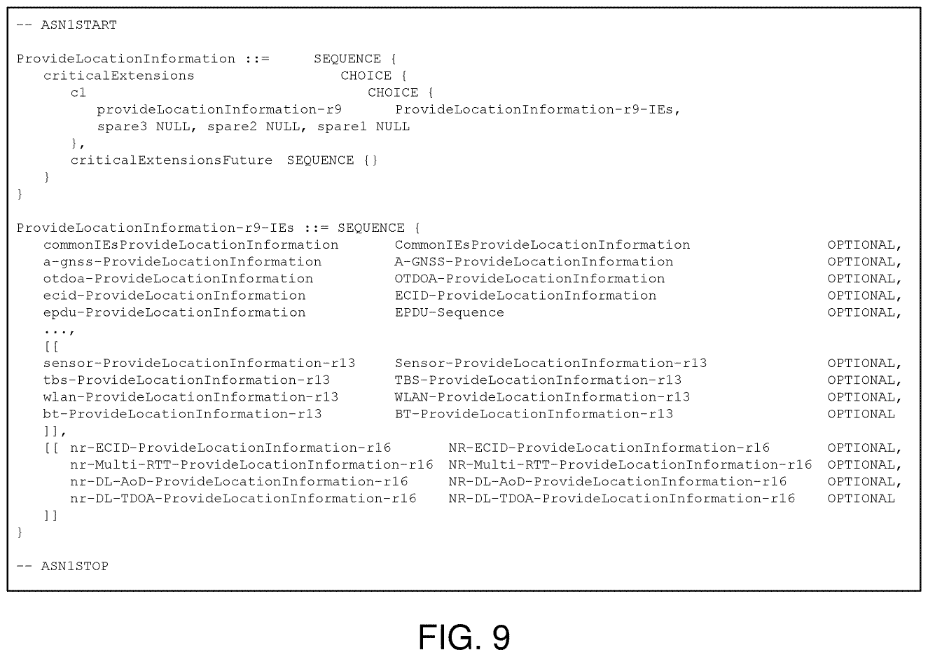

UE measurements which are applicable to DL-based positioning techniques are discussed below. For a conceptual overview, the measurement configuration (see FIG. 8) and reporting configuration (see FIG. 9) may be provided for each of the supported positioning techniques.

FIG. 8 shows one example of an ASN.1 implementation of the RequestLocationInformation message body in an LTE Positioning Protocol (LPP) message. The RequestLocationInformation message body in an LPP message is used by the location server to request positioning measurements or a position estimate from the target device.

FIG. 9 shows one example of an ASN.1 implementation of the ProvideLocationInformation message body in a LPP message. The ProvideLocationInformation message body in an LPP message is used by the target device to provide positioning measurements or position estimates to the location server.

Regarding RAT-dependent Positioning Measurements, the different DL measurements including DL PRS-RSRP, DL RSTD and UE Rx-Tx Time Difference required for the supported RAT-dependent positioning techniques are shown in Table 4. The following measurement configurations are specified as follows: A) 4 Pair of DL RSTD measurements can be performed per pair of cells (each measurement is performed between a different pair of DL PRS Resources/Resource Sets with a single reference timing); B) 8 DL PRS RSRP measurements can be performed on different DL PRS resources from the same cell.

TABLE 4
DL Measurements required for DL-based positioning techniques

DL PRS reference signal received power (RSRP)

| | |
|---|---|
| Definition | DL PRS reference signal received power (DL PRS-RSRP), is defined as the linear |
| | average over the power contributions (in [W]) of the resource elements that carry DL |
| | PRS reference signals configured for RSRP measurements within the considered |
| | measurement frequency bandwidth. |
| | For FR1, the reference point for the DL PRS-RSRP shall be the antenna connector of |
| | the UE. For FR2, DL PRS-RSRP shall be measured based on the combined signal |
| | from antenna elements corresponding to a given receiver branch. For FR1 and FR2, if |
| | receiver diversity is in use by the UE, the reported DL PRS-RSRP value shall not be |
| | lower than the corresponding DL PRS-RSRP of any of the individual receiver |
| | branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing difference |
| | between the positioning node j and the reference positioning node i, defined as |
| | T_{SubframeRxj} − T_{SubframeRxi}, |
| | Where: |
| | T_{SubframeRxj} is the time when the UE receives the start of one subframe from positioning |
| | node j. |
| | T_{SubframeRxi} is the time when the UE receives the corresponding start of one subframe |
| | from positioning node i that is closest in time to the subframe received from |
| | positioning node j. |
| | Multiple DL PRS resources can be used to determine the start of one subframe from a |
| | positioning node. |
| | For FR1, the reference point for the DL RSTD shall be the antenna connector of the |
| | UE. For FR2, the reference point for the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning node, |
| | defined by the first detected path in time. |
| | T_{UE-TX} is the UE transmit timing of uplink subframe #j that is closest in time to the |
| | subframe #i received from the positioning node. |
| | Multiple DL PRS resources can be used to determine the start of one subframe of the |
| | first arrival path of the positioning node. |
| | For FR1, the reference point for T_{UE-RX} measurement shall be the Rx antenna connector |
| | of the UE and the reference point for T_{UE-TX} measurement shall be the Tx antenna |
| | connector of the UE. For FR2, the reference point for T_{UE-RX} measurement shall be the |
| | Rx antenna of the UE and the reference point for T_{UE-TX} measurement shall be the Tx |
| | antenna of the UE. |
| Applicable for | RRC_CONNECTED intra-frequency |
| | RRC_CONNECTED inter-frequency |

The integrity and reliability of the positioning estimate is defined by the following parameters: Alert Limit (AL); Time-to-Alert (TTA); Target Integrity Risk (TIR); Protection Level (PL).

The AL parameter indicates the maximum allowable positioning error such that the positioning system is available for the intended application. If the positioning error is beyond the AL parameter, operations are hazardous, and the positioning system should be declared unavailable for the intended application to prevent loss of integrity. Note that when the AL parameter bounds the positioning error in the horizontal plane or on the vertical axis, then it is called Horizontal Alert Limit (HAL) or Vertical Alert Limit (VAL), respectively.

The TTA parameter indicates the probability that the positioning error exceeds the AL parameter without warning the user within the required time defined by the TTA parameter.

The TIR parameter indicates the maximum allowable elapsed time from when the positioning error exceeds the AL parameter until the function providing position integrity annunciates a corresponding alert. Note that the TIR parameter is usually defined as a probability rate per some time unit (e.g., per hour, per second or per independent sample).

The PL parameter is a real-time upper bound on the positioning error at the required degree of confidence, where the degree of confidence is determined by the TIR probability. The PL is a statistical upper-bound of the Positioning Error (PE) that ensures that the probability per unit of time of the true error being greater than the AL and the PL being less than or equal to the AL, for longer than the TTA, is less than the required TIR, i.e., the PL satisfies the following inequality:

$$Prob per unit of time [ ( ( PE > AL ) \& ( PL <= AL ) ) for longer than TTA ] < required TIR$$

In the case of SL positioning, coordinated and efficient resource allocation for involved devices/nodes within a SL positioning session is essential to obtain good SL Positioning performance (e.g., good accuracy and low latency positioning). In the case of SL positioning techniques, which require the involvement of multiple nodes/entities, tight coordination of resources and transmissions may be required within a so-called SL positioning group to minimize delays and increase efficiency of the resource allocation procedures.

This present disclosure details solutions for enhancing the distributed resource allocation for UEs/devices performing SL positioning, especially considering positioning techniques which require the involvement of one or more UEs. An overview of the solutions is presented as follows:

A first solution describes procedures to request time-frequency SL positioning resources by a configuration UE (or configuration node or configuration device) on behalf of members within a SL positioning group from another network entity, e.g., gNB or RSU.

A second solution describes procedures to provide a suitable response to the configuration UE (or configuration node or configuration device) in response to a SL positioning request.

A third solution describes procedures to schedule, process, and transfer time-frequency SL positioning resources other members within a SL positioning group.

A fourth solution describes procedures to request additional resources and associated configuration updates, which may be triggered by individual SL positioning group members or by the configuration UE (or other configuration device/node) based on the fulfilment of certain SL positioning conditions.

A fifth solution describes procedures for Mode-2 resource allocation by SL positioning group members. Note that the solutions described herein may be implemented in combination with each other to support NR RAT-dependent positioning methods over the SL interface (e.g., PC5 interface).

For the purposes of this disclosure, a positioning-related reference signal may be referred to as a reference signal used for positioning procedures/purposes in order to estimate a target-UE's location, e.g., PRS, or based on existing reference signals such as Channel State Information Reference Signal (CSI-RS) or Sounding Reference Signal (SRS); a target-UE may be referred to as the device/entity to be localized/positioned. In various embodiments, the term “PRS” may refer to any signal such as a reference signal, which may be used for positioning, even if the signal is not used primarily for positioning.

SL positioning techniques include, but are not limited to, RTT-type solutions using SL (to include both single-sided (also known as one-way) and double-sided (also known as two-way) RTT); Sidelink Angle-of-Arrival (SL-AoA) (to include both A-AoA and Z-AoA); SL-TDOA (makes use of the SL RSTD (and optionally SL PRS RSRP) of SL signals received from multiple TPs, at the UE); Sidelink Angle-of-Departure (SL-AoD) (corresponds to a method where RSRP and/or RSRPP measurements similar to the DL-AoD method in Uu, to include both Azimuth Angle-of-Departure (A-AoD) and Zenith Angle-of-Departure (Z-AoD)).

An initiator device, as used herein, initiates a SL positioning/ranging session, may be a network entity (e.g., gNB, LMF), a UE, and/or a roadside unit (RSU). A RSU refers to a transportation infrastructure entity (e.g., an entity transmitting speed notifications or other V2X-related notifications). An RSU performing UE-like behaviors is referred to as a UE-type RSU, while an RSU performing BS-like behaviors is referred to as a gNB-type RSU.

A responder device, as used herein, responds to a SL positioning/ranging session from an initiator device, may be a network entity, (e.g., gNB, LMF), a UE and/or a RSU.

A target-UE, as used herein, refers to as a UE of interest whose position (absolute or relative) is to be obtained by the network and/or by the UE itself.

Sidelink positioning, as used herein, refers to using reference signals transmitted over SL, i.e., PC5 interface, to obtain absolute position, relative position, or ranging information.

Ranging, as used herein, refers to the determination of the distance and/or the direction between a UE and another entity, e.g., anchor UE.

Anchor UE, as used herein, refers to a UE supporting positioning of a target UE, e.g., by transmitting and/or receiving reference signals for positioning, providing positioning-related information, etc., over the SL interface. An anchor UE may also be referred to as SL Reference UE.

Assistant UE, as used herein, refers to a UE supporting Ranging/Sidelink between a SL Reference UE and Target UE over PC5, when the direct Ranging/Sidelink positioning between the SL Reference UE/Anchor UE and the Target UE cannot be supported. The measurement/results of the Ranging/Sidelink Positioning between the Assistance UE and the SL Reference UE and that between the Assistance UE and the Target UE are determined and used to derive the Ranging/Sidelink Positioning results between Target UE and SL Reference UE.

SL Positioning Server UE, as used herein, refers to a UE offering location calculation, for Sidelink Positioning and Ranging based service. It interacts with other UEs over PC5 as necessary in order to calculate the location of the Target UE. Target UE or SL Reference UE can act as SL Positioning Server UE if location calculation is supported.

SL Positioning Client UE, as used herein, refers to a third-party UE, other than SL Reference UE and Target UE, which initiates Ranging/Sidelink positioning service request on behalf of the application residing on it.

SL positioning node, as used herein, may refer to a network entity and/or device/UE participating in a SL positioning session, e.g., LMF (location server), gNB, UE, RSU, anchor UE, Initiator and/or Responder UE.

Configuration entity, as used herein, refers to a network node or device/UE capable of configuring time-frequency resources and related SL positioning configurations.

The embodiments of the first solution relate to triggering and request for SL positioning group resources. According to the first solution, a configuration entity (e.g., configuration UE) may initiate a request for time-frequency SL positioning resources on behalf of all members within a SL positioning group to a network entity/node, e.g., gNB, LMF or gNB-type RSU. The SL positioning group may be defined as any two or more UEs (or devices or nodes) performing SL positioning with the intention of determining the absolute/relative position estimate of one of the members of the SL positioning group.

In an alternative implementation, the absolute/relative position estimate of a non-member of a SL positioning group may also be determined with the appropriated request and response pair of messages to determine the absolute/relative position estimate of the non-member UE.

A SL positioning group may be established for the purposes of locating the target-UE in terms of absolute/relative location estimation using a plurality of SL positioning techniques, e.g., SL-TDOA, SL-RTT, SL-AoA, SL-AoD, etc. The SL positioning group may be established on the higher layers, e.g., SL Positioning Protocol (SLPP) layer, Ranging SL Positioning Protocol (RSPP) layer, V2X/ProSe layer, application layer with the associated SL positioning group information including SL Group ID, SL group members, group size, group capability information.

In another implementation, the SL Positioning Group may be established on the AS layer/RAN/lower layers, based on the resource availability, number of available SL positioning UEs involved in a SL positioning session, e.g., Anchor/Reference UEs.

The SL positioning group may be composed of the following nodes/UEs/devices: a set of anchor UEs/devices/nodes, UE-type RSUs, a target-UE, a SL Positioning Server UE, Reference UE, an Assistant UE, or a combination thereof. Furthermore, the configuration UE (or configuration node or configuration device) may also comprise one of the following: one anchor UE within a set of anchor UEs/devices/nodes, target-UE, SL positioning server UE, Reference UE assistant UE.

In an alternative implementation, the aforementioned one or more types of UE may reside in a single UE based on a SL positioning UE capability/feature.

According to one aspect of the first solution, the configuration entity (e.g., configuration UE) may transmit a resource request to a network entity such as gNB or gNB-type RSU, LMF. This may be triggered upon receiving a SL positioning/ranging request from the higher-layer, e.g., application layer, ProSe/V2X application layer, dedicated SL positioning layer. In this aspect, the SL positioning members, target-UE, and configuration UE (or configuration node or configuration device) is known to all members of the group, which can be indicated by the higher-layers, e.g., application layer, ProSe/V2X application layer, dedicated SL positioning layer.

In another implementation, the SL positioning group may be established in the AS layer via dynamic assignment of available anchor UE, reference UEs, assistant UE, SL Positioning Server UEs.

The content of the resource request for SL positioning by the configuration UE (or configuration node or configuration device) may include one or more of the following:

A request mapping of assignment or release of SL time-frequency positioning resources for each member of the SL positioning group, including the configuration UE (or configuration node or configuration device). In one implementation, the configuration UE (or configuration node or configuration device) may request for one or more members of the SL positioning group. In another implementation, the configuration UE (or configuration node or configuration device) may request for a subset of resources designed to transmit SL PRS, e.g., a dedicated set of resources for anchor UEs/nodes or the target-UE and another subset of resources to transmit SL positioning messages, e.g., using a shared set of resource with data to exchange messages such as capability information, assistance data information, measurement configurations and reports, location information, error/abort messages.

ID information of the member UEs including the configuration UE (or configuration node or configuration device) for which the resources are requested, which may comprise the L1-ID derived from L2-IDs, L2-IDs, IDs derived from the higher-layer, e.g., application layer, ProSe/V2X application layer, dedicated SL positioning layer comprising of e.g., SL positioning layer source ID and/or SL positioning layer destination ID. The ID information may comprise the existing source and/or destination IDs or, in another implementation, may comprise SL positioning-specific source and/or destination IDs. In an extended implementation, the ID information may extend to the type of positioning measurement reported by each member depending on the SL positioning technique and associated positioning measurement.

An indication that the SL positioning group is interested or no longer interested in performing SL positioning, which entails the transmission and reception by each group member of SL positioning messages and reference signals. For example, this may be in the form of a flag indication. In a further implementation, the configuration UE (or configuration node or configuration device) may also indicate individual members interested or no longer interested in transmitting or receiving SL positioning messages.

SL positioning QoS parameters or SL positioning QoS profile, which may be received by the higher layers, for a one or more SL positioning/ranging services. These QoS parameters may comprise absolute/relative horizontal and/vertical accuracy, SL positioning latency, Time-to-First-Fix (TTFF), response time, positioning reliability, integrity metrics including PL, AL, TTA, desired time in advance for a positioning/ranging fix, direction accuracy in terms of azimuth and/or elevation angles, attitude/orientation accuracy or the like.

The SL positioning capabilities of the configuration UE (or configuration node or configuration device) and the SL positioning group members.

The associated SL positioning Session ID for which the resources are to be requested.

The associated SL positioning group ID for which the resources are to be requested. The SL positioning group ID may comprise the L1-ID derived from L2-IDs, L2-IDs, IDs derived from the higher-layer, e.g., application layer, ProSe/V2X application layer, dedicated SL positioning layer.

The applicable positioning technique associated to the SL positioning session and used by the SL positioning group to determine the positioning estimate of the target-UE, e.g., SL-TDOA, SL-RTT (one-way or two-way), SL-AoA, SL-AoD, SL E-CID, etc.

An indicator conveying the type of positioning node for which are the resources are requested, which may include one of the following: a set of anchor/Reference UEs/devices/nodes, Client UE, UE-type RSUs, target-UE, SL Positioning Server UE, Reference UE, assistant UE, or combination thereof.

The SL positioning resource request may be requested in varying forms of granularity ranging from individual Resource Elements (REs), individual SL positioning resources with an associated ID, SL positioning resource sets (collection of SL positioning resources), SL positioning resources associated with an SL bandwidth part (BWP), SL positioning resources associated with a SL positioning frequency layer, shared resources meant for both SL positioning reference signals and SL control-plane and user-plane messages.

The aforementioned resource request signaling may be signaled to network entity/node via lower-layer and/or higher-layer signaling options, e.g., uplink control information (UCI), UL MAC control element (CE), RRC signaling, e.g., using the Sidelink UE information message, LPP signaling. In another implementation, the request signaling may be transmitted to another centralized entity such as an RSU, using SL (i.e., PC5) signaling such as PC5 RRC messages such as RRCReconfigurationSidelink or the like, a new SL positioning protocol (e.g., SLPP or RSPP) via exemplary messages used to configure SL-PRS configurations or assistance data, e.g., RequestSLPositioningAssistanceData and/or ProvideSLPositioningAssistanceData.

In another implementation, in the event that the configuration UE (or configuration node or configuration device) has detected a radio link failure (RLF) or beam failure, the SL positioning group resource request is re-transmitted.

In another implementation, in the event that the configuration entity (e.g., configuration UE) has lost connectivity for a period of time defined, e.g., by a timer, the SL positioning resource request may be transmitted by a second candidate configuration entity from a list of candidate configuration entities (e.g., configuration UEs) within a group. The list of candidate configuration UE (or configuration node or configuration device) may be groupcasted along PC5, e.g., using the PC5 RRC or SLPP/RSPP to all member UEs. The list of candidate configuration UE (or configuration node or configuration device)s may be available to all group members upon group establishment.

In an alternative implementation, the list of candidate configuration UEs/devices/nodes may be received from a central configuration entity via UE-specific signaling, e.g., RRC, LPP signaling or broadcast signaling using positioning system information broadcasts or system information broadcasts.

According to an aspect of this first solution, the request for SL positioning time-frequency resources may comprise a structure defined by one or more of the following: slots across time domain, subchannels across frequency domain, SL positioning resource(s), SL positioning resource set(s), dedicated SL positioning pool(s), share pool enabling the transmission of both SL positioning information (e.g., SL PRS, measurement reports) and normal SL data, dedicated SL BWP for SL positioning, SL positioning frequency layer, dedicated frequency layer for SL positioning, e.g., SL positioning frequency layer. Each of these resource structures may be associated one ID, or set of IDs depending on the resource hierarchy.

The embodiments of the second solution relate to the corresponding response to a SL positioning group resource request. According to the second solution, the network entity/node, e.g., gNB or RSU receiving the SL positioning resource request may respond in a variety of ways depending on the availability of resources, priority with respect to SL data requests and number of UEs/devices/nodes within a SL positioning group.

According to one aspect of the second solution, the network entity/node, e.g., gNB, LMF or RSU, may respond with SL positioning resource profile comprising a plurality of allocated resources to each member of the SL Positioning group.

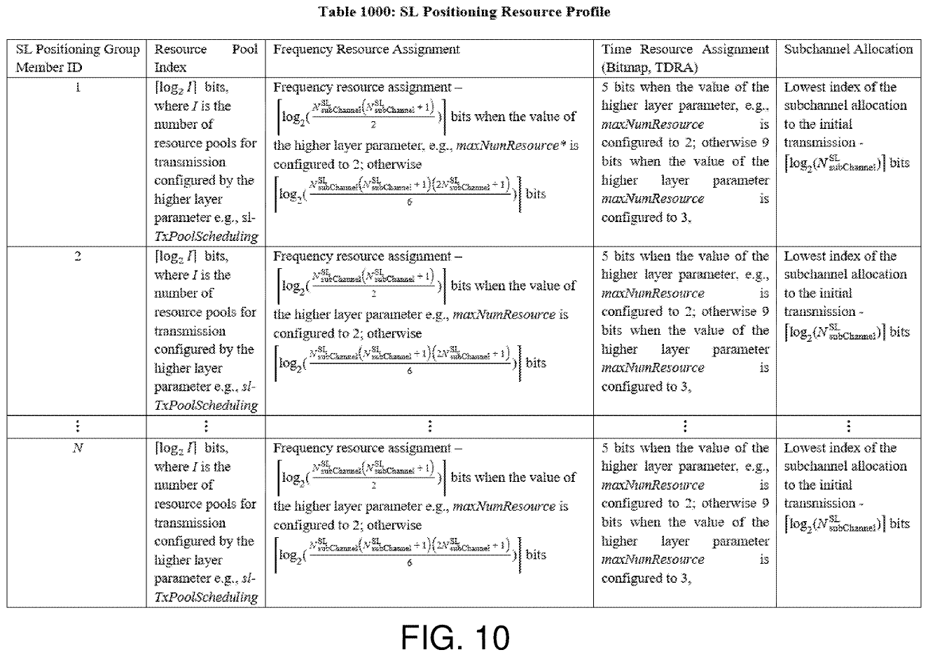

FIG. 10 depicts an exemplary Table 1000 that illustrates a SL positioning resource profile, according to embodiments of the disclosure. In another extended implementation, Table 1000, may also include one or more additional parameters that may assist in the transmission of the SL-PRS over the provided time-frequency resources, e.g., number of symbols, comb-size (comb-pattern) including indication about staggered and/or partial staggered transmission, frequency shift/offset, SL PRS resource slot and/or time and/or symbol offset (may relate to resource set and/or resource offsets), SL PRS periodicity, repetition information including number of repetitions, repetition factor, SL PRS resource power, SL PRS sequence ID, muting information, configured bandwidth, SL PRS resource priority information or combination thereof. In one implementation, the Table 1000 may be signaled to the configuration entity (e.g., configuration UE). In another embodiment, the Table 1000 may be signaled to each of the members within a SL positioning group. This signaling may be in the form of a new downlink control information (DCI) format for the purposes of SL positioning resource scheduling.

According to one aspect of the Embodiment, the SL Positioning Group member identification (ID) may in the resource profile may also further indicate the individual roles of each SL positioning group member including whether each UE/device may act as an anchor UE/device/node, target-UE, SL Positioning Server UE, Reference UE, assistance UE, SL positioning reference unit. Such group member IDs may implicitly signal, e.g., to be derived by the receiving member UE or explicitly signaled.

In another aspect of the second solution, the resources allocated by the central configuration entity may be dynamic, i.e., one time allocation of resource for all or a subset of the SL positioning group members, semi-persistent set of SL positioning resources, with an associated explicit/implicit activation/deactivation command, periodicity, offset with respect to a reference time, e.g., SL System Frame Number (SFN), periodic allocation with an associated periodicity, offset with respect to a reference time, e.g., SL SFN, resource duration.

The aforementioned resource response signaling may be signaled to the configuration UE (or configuration node or configuration device) or to the individual member UEs via lower-layer and/or higher-layer signaling options, e.g., DL MAC CE, RRC signaling, LPP signaling. In another implementation, the response signaling may be received from another centralized entity such as an RSU, using SL (PC5) signaling such as PC5 RRC messages such as RRCReconfigurationSidelink or the like, a new SL positioning protocol (e.g., SLPP and/or RSPP) via exemplary messages used to configure SL-PRS configurations or assistance data, e.g., RequestSLPositioningAssistanceData and/or ProvideSLPositioningAssistanceData.

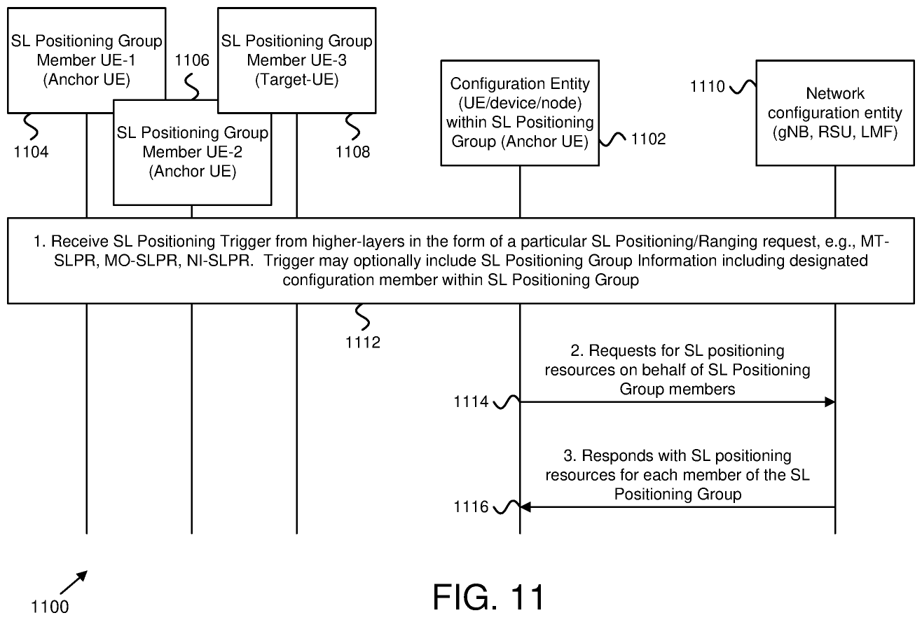

FIG. 11 is a basic illustration of the overall procedure 1100 covered by both the first and second solutions. The procedure 1100 involves a configuration entity 1102 (e.g., configuration UE, or device, or node) within a SL Positioning Group, a first SL Positioning Group member UE (denoted “UE-1”) 1104, a second SL Positioning Group member UE (denoted “UE-2”) 1106, a third SL Positioning Group member UE (denoted “UE-3”) 1108, and a network configuration entity 1110 (e.g., a gNB, a RSU, or an LMF). The steps of the procedure 1100 are as follows:

At Step 1, at least one or more of the SL positioning involved network entities and/or nodes receives a trigger from the higher-layers, e.g., application layer, ProSe/V2X application layer, dedicated SL positioning layer to perform SL positioning with the aid of a SL positioning group (see block 1112). The trigger may further indicate the type of SL positioning/ranging request including MT-SLPR (Mobile terminated SL positioning request), MO-SLPR (Mobile originated SL positioning request) or NI-SLPR (Network Induced SL positioning request), Standalone ranging for distance and/or ranging for direction request. In another implementation, the trigger may be received from another UE type, e.g., Client UE.

In addition, the trigger information provided by the higher-layers may also include the further details (e.g., member information) of the SL positioning group including which of the SL positioning group member have assigned roles, e.g., a set of anchor UEs/devices/nodes, target-UE, SL Positioning Server UE, Reference UE, assistance UE, SL positioning reference unit. In the depicted embodiment, the configuration entity 1102 is an anchor UE, the UE-1 1104 is an anchor UE, the UE-2 1106 is an anchor UE, while the UE-3 is the target-UE.

In an alternative implementation of Step 1, the details of the SL Positioning Group may be determined on the RAN level (AS level) depending on the SL positioning technique, availability of resources and SL Positioning QoS parameters such as absolute/relative horizontal and/vertical accuracy, SL positioning latency, TTFF, response time, positioning reliability, integrity metrics (e.g., PL, AL, and/or TTA), desired time in advance for a positioning/ranging fix, direction accuracy in terms of azimuth and/or elevation angles, attitude/orientation accuracy or the like.

At Step 2, the designated/configured configuration entity 1102 transmits a SL Positioning Group resource request to a central configuration entity, i.e., the network configuration entity 1110 (see messaging 1114). This request may include the content as described above in the first solution. Note that transmitting the SL Positioning Group resource request may be realized be developing separate SL positioning scheduling requests to be specified with a separate Scheduling Request (SR) ID.

At Step 3, the network configuration entity 1110, i.e., central configuration entity, responds with the available SL positioning resources according to the requirements for each individual member of the SL positioning group (see messaging 1116). This request may include the content as described above in the second solution. The available SL positioning resources may be based on a variety of factors included relative SL Positioning QoS relative to other SL positioning groups, number of members within a SL positioning group, type of configured positioning techniques, e.g., SL-RTT, SL-TDOA, SL-AoA, SL-AoD, or the like.

The embodiments of the third solution relate to the scheduling and processing of SL positioning group resources. According to the third solution, a configuration UE (or configuration node or configuration device) may receive the requested or available time-frequency SL positioning resources on behalf of all members within a SL positioning group from a network entity/node, e.g., gNB, LMF or RSU (e.g., gNB-type) or another scheduling UE.

The SL positioning group may be defined as any two or more UEs/devices/nodes performing SL positioning with the intention of determining the absolute/relative position estimate of one of the members of the SL positioning group. In an alternative implementation, the absolute/relative position estimate of a non-member of a SL positioning group may also be determined with the appropriated request and response pair of messages to determine the absolute/relative position estimate of the non-member UE.

A SL positioning group may be established for the purposes of locating the target-UE in terms of absolute/relative location estimation using a plurality of SL positioning techniques, e.g., SL-TDOA, SL-RTT, SL-AoA, SL-AoD. The SL positioning group may comprise the following nodes/UEs/devices: a set of anchor UEs/devices/nodes (Reference UEs), UE-type RSUs, target-UE, SL positioning server UE, Client UE, assistant UE, or combination thereof. Furthermore, the configuration UE (or configuration node or configuration device) may also comprise one of the following: one anchor UE within a set of anchor UEs/devices/nodes, target-UE, SL positioning server UE, Reference UE, assistant UE, client UE. In an alternative implementation, the aforementioned one or more types of UE may reside in a single UE based on a SL positioning UE capability/feature.

According to aspects of the third solution, the configuration entity (e.g., configuration UE) may fulfill one or more of the following functions in terms of resource scheduling and allocation for each of the SL Positioning group members.

In one aspect of the third solution, the configuration entity (e.g., configuration UE) schedules the plurality of received time-frequency resources from a central configuration entity on behalf each of the SL Positioning group members. This entails additional capabilities by the configuration UE (or configuration node or configuration device) to allocate and divide the total received resources amongst each SL positioning group member.

In some embodiments, a criterion for the SL positioning time-frequency resource allocation may be dependent on the type of transmission by each SL Positioning group member UE, e.g., SL PRS transmission—may require high bandwidth resources in a dedicated SL positioning resource pool, transfer of SL positioning assistance data (SL positioning configuration data) or SL Measurement report—may share resources with SL data (using a shared resource pool) to transmit the SL positioning measurement report.

In a further implementation, the type of SL PRS transmission may include an always-on type transmission, where SL-PRS is transmitted indefinitely based on the transmission of an activation and deactivation command. In an alternative further implementation, the type of SL PRS transmission may include an on-demand SL-PRS type transmission, where SL-PRS transmission is based on a request and response pair of messages.

In some embodiments, a criterion for the SL positioning time-frequency resource allocation may be dependent on the type of SL PRS (pre-)configuration, wherein the configuration comprises number of symbols, comb-size (comb-pattern), whether repetitions are required or not, staggered and/or partial staggered design, muting required or not, configured bandwidth.

In some embodiments, a criterion for the SL positioning time-frequency resource allocation may be dependent on the measurement report size and time domain pattern of the measurement report, e.g., one-shot, aperiodic, periodic, semi-persistent, event triggered.

In some embodiments, a criterion for the SL positioning time-frequency resource allocation may be dependent on the SL Positioning priority of each SL Positioning Group member based on the type of SL positioning transmission, e.g., SL PRS transmission, this may be defined as a SL Group positioning priority for resource allocation and SL positioning transmission among all group members. In alternative implementation, a separate priority may be defined with respect to SL data transmissions and thus may also be used as a criterion to determine SL positioning resource scheduling and allocation.

In some embodiments, a criterion for the SL positioning time-frequency resource allocation may be dependent on the configured positioning technique, e.g., SL-TDOA, SL-AoA, SL-AoD, SL-RTT including one-way/single-sided RTT or two-way/double-sided RTT, multi-node RTT.

In some embodiments, a criterion for the SL positioning time-frequency resource allocation may be dependent on whether each of the SL positioning group members already has an existing SL positioning resource allocation and/or SL Data allocation configuration. If yes, then the SL positioning group member should provide an indication to the configuration UE via SL MAC CE, PC5 RRC signaling, SL positioning protocol (e.g., SLPP/RSPP) via configuration or assistance signaling.

In one aspect of the third solution, the central configuration entity (e.g., network entity) provides the defined time-frequency resources based on the SL PRS configuration for each of the member UEs and the configuration entity (e.g., configuration UE), which relays/forwards this resource allocation configuration to each of SL Positioning group members without any modifications. The central configuration entity is aware of the SL PRS configuration based on information/assistance information provided by the configuration UE or each of the group members via solicited request and response signaling or unsolicited response signaling.

The SL PRS configuration may comprise resource ID information, number of symbols, comb-size (comb-pattern) including indication about staggered and/or partial staggered transmission, frequency shift/offset, SL PRS resource slot and/or time and/or symbol offset (may relate to resource set and/or resource offsets), SL PRS periodicity, repetition information including number of repetitions, repetition factor, SL PRS resource power, SL PRS sequence ID, muting information, configured bandwidth, SL PRS resource priority information or combination thereof.

In one aspect of the third solution, the central configuration entity (e.g., network entity) provides the totality of time-frequency resource configurations to the configuration UE, which then provides the subset of resources from the totality of received resources based on the SL PRS configuration to each of the member UEs. In this case, the configuration UE will configure the appropriate SL PRS configuration to each of the member UEs transmitting SL PRS. In addition, the configuration UE will also allocate the subset of resources from the total received resources from the configuration entity.

The SL PRS configuration to be signaled by the configuration UE (e.g., configuration entity) may comprise resource ID information, number of symbols, comb-size (comb-pattern) including indication about staggered and/or partial staggered transmission, frequency/RE shift/offset, SL PRS resource slot and/or time and/or symbol offset (may relate to resource set and/or resource offsets), SL PRS periodicity, repetition information including number of repetitions, repetition factor, SL PRS resource power, SL PRS sequence ID, muting information, configured bandwidth, SL PRS resource priority information or combination thereof. One or more of these aforementioned SL PRS configuration parameters may be adapted/modified/configured by the configuration UE for each of the SL group members (including itself).

In one aspect of the third solution, the central configuration entity (e.g., network entity) provides the totality of time-frequency resource configurations to the configuration UE, which then provides the subset of resources from the totality of received resources based on a subset of the SL PRS configuration to each of the member UEs, where thereafter the member UEs derive some of the SL PRS configuration parameters in an implicit manner based on a set of criteria to receive its subset of resource allocation. The subset of SL PRS configuration may comprise one or more of the parameters described above.

The criteria to derive the remaining subset of the SL PRS configuration, e.g., the SL PRS frequency shift/RE offset, resource priority may be based on the following criteria: A) Member UE/device may derive parameters such as the SL PRS frequency shift/RE offset based on its own L1/L2 ID information depending on its SL positioning role, e.g., anchor UEs/devices/nodes (Reference UEs), UE-type RSUs, target-UE, SL positioning server UE, Client UE, assistant UE, or combination thereof, B) Other SL PRS parameters may be based on pre-configured parameters or any deltas/changes with respect to the received SL PRS configuration; of C) a combination thereof.

According to the third solution, the configuration UE may initially provide the subset of resource based on the above implementations/functions and thereafter may further the transmit a resource activation/deactivation of the configured resources. A deactivation of the resource may indicate that the resources are released and may be used by other member UEs or other SL UEs for SL positioning procedures or SL Data communication procedures. The configuration UE may activate or deactivate subset of resource from one or more member UEs.

In a further implementation, the member UEs may also signal an activation/deactivation request to the configuration UE via sidelink control information (SCI), configuration/assistance/report PC5 RRC signaling or via configuration/assistance/report SL positioning protocol signaling once the required SL positioning transmissions have been completed. In an alternative implementation the activation and/or deactivation may be received directly from the central configuration entity via DCI, DL MAC CE, RRC, or LPP signaling.

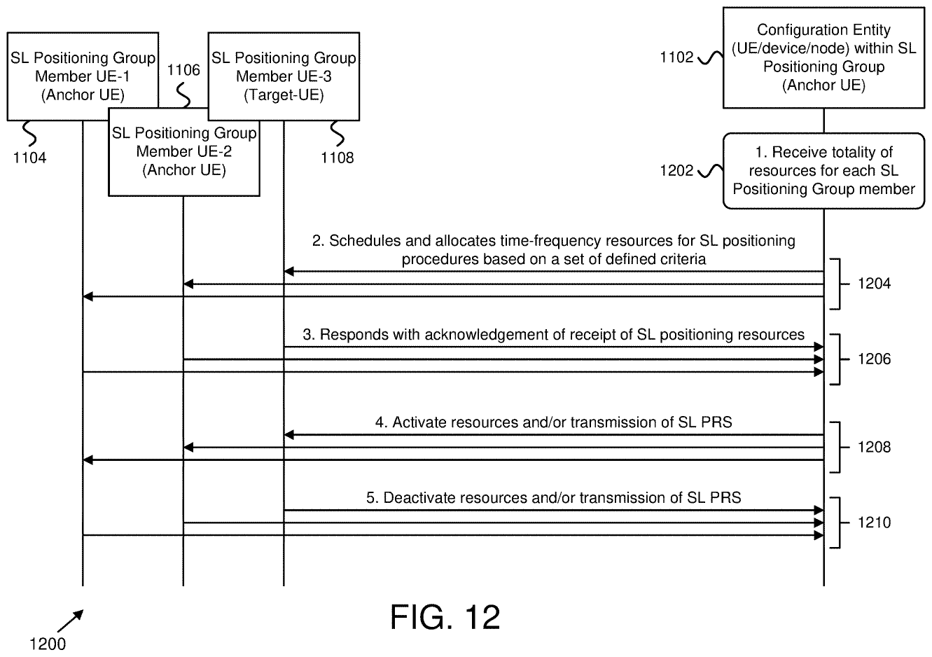

FIG. 12 depicts a procedure 1200 for the resource scheduling and allocation for each SL positioning group member UE, according to embodiments of the third solution. The procedure 1100 involves a configuration entity 1102 (e.g., configuration UE, or device, or node) within a SL Positioning Group, a first SL Positioning Group member UE (denoted “UE-1”) 1104, a second SL Positioning Group member UE (denoted “UE-2”) 1106, a third SL Positioning Group member UE (denoted “UE-3”) 1108. The steps are detailed as follows:

At Step 1, the configuration entity 1102 receives a total set of SL positioning time-frequency resources (see block 1202). The procedures of requesting and receiving the total set of SL positioning time-frequency resources are described above in the first and second solutions. In one implementation, these resource are received in a one-shot manner. In another implementation, the total received resources may be received periodically over time.

At Step 2, the configuration entity 1102 schedules and processes the total set of resources and transmits a subset of the resource to each SL positioning group member based on a set of criteria as described above (see messaging 1204).

At Step 3, each of the SL positioning group members may transmit an acknowledgment of receipt of subset of resources to the configuration entity 1102 (see messaging 1206). In certain embodiments, fewer than all of the SL positioning group members may transmit this acknowledgment.

At Step 4, the configuration entity 1102 may activate the resources and/or SL PRS transmission using SL (PC5) configuration/assistance/report signalie.g., e.g., SCI, PC5 RRC signaling, SL positioning protocol signaling (see messaging 1208).

At Step 5, the configuration entity 1102 may deactivate the resources and/or SL PRS transmission using SL (PC5) configuration/assistance/report sige.g., ng, e.g., SCI, PC5 RRC signaling, SL positioning protocol signaling (see messaging 1210).

According to an aspect of the third solution, the SL positioning time-frequency resources may be scheduled for one-shot pe.g., ioning, e.g., resources of contiguous subchannels in frequency and contiguous slots in the time domain, or for periodic e.g., ositioning, e.g., a set of resources which are periodically repeated with a configured periodicity and slot offset.

According to an aspect of the third solution, the SL positioning time-frequency resources may comprise a structure defined by one or more of the following: slots across time domain, subchannels across frequency domain, SL positioning resource(s), SL positioning resource set(s), dedicated SL positioning pool(s), shared pool(s) enabling the transmission of both SL posite.g., ng information (e.g., SL PRS, measurement reports) and normal SL data, dedicated SL BWP for SL positioning, SL positioning frequency layer, dedicated frequency lae.g., for SL positioning, e.g., SL positioning frequency layer. Each of these resource structures may be associated one ID, or set of IDs depending on the resource hierarchy.

In a further aspect of the third solution, the configuration UE may schedule member UEs who operate in diffee.g., communications states, e.g., subset of Member UEs operating in RRC_CONNECTED, another subset of UEs in RRC_INACTIVE state, while another subset of UEs in RRC_IDLE state. Members UEs in RRC_INACTIVE or RRC_IDLE state may not receive any SL Group resource allocation information from the central configuration entity and may rely on the configuration UE for resource configurations needed to transmit SL positioning reference signals and messages or rely on pre-configured resource information.

In another aspect of the third solution, the member UEs may acknowledge the receipt of the resource configuration from either the configuration UE via configuration/assistance/report PC5 RRC signaling, SL e.g., tioning protocol signaling, e.g., a new SLPP/RSPP message such as RequestSLPositioningAssistanceData or ProvideSLPositioningAssistanceData, or to a central configuration entity via UL MAC CE, RRC, LPP signaling.

The embodiments of the fourth solution relate to the request for re-transmission or re-allocation of SL positioning group resources. According to the fourth solution, the member UEs of the SL positioning group may transmit a SL positioning resource re-transmission request, additional resource and/or resource re-allocation request when certain condition/triggers are met as described in the following scenarios:

In some embodiments, a SL positioning group member may request to re-transmit the subset of resources to be scheduled and allocated by the configuration UE in the event that the resources have not been received successfully.

In some embodiments, a SL positioning group member may request to re-allocate the subset of resources scheduled and allocated by the configuration UE in the event that the resources are deemed not sufficient for the pe.g., cular SL positioning procedure, e.g., SL PRS transmission, etc.

In an alternative implementation of the fourth solution, the SL positioning group member may request a new/updated set of resources based on a change of SL positioning QoS implying a denser/sparser SL PRS resource configuration. This change may comprise an incre.g., or decrease of SL positioning QoS, e.g., tighter or looser accuracy or latency requirements.

In an alternative implementation of the fourth solution, the SL positioning group member may request a new/updated set of resources based on a change of SL positioning technique. This change may comprise the use of a different SL positioning technique when compared to the original configured technique or the use additional SL positioning techniques in addition to the originally configured technique.

In an alternative implementation, a new/updated set of resources may re-allocae.g., based on a change of coverage scenario, e.g., moving from in-coverage to out-of-coverage.

In an alternative implementation, the SL positioning group member may request a new/updated set of resources may re-allocated based on an update of an existing pre-configured set of resource for SL positioning. Note that the above implementations may be defined as a set of conditions in which to request an update or re-allocation of resources.

In various embodiments, the request an update or re-allocation of resources may be transmitted to: A) the configuration UE via configuration/assistance/report PC5 RRC signaling or a novel SL positioning protocol (SLPP or RSPP) via exemplary messages used to configure SL-PRS configurations or assistance date.g., report SL positioning-related information, e.g., RequestSLPositioningAssistanceData and/or ProvideSLPositioningAssistanceData; or B) To a central configuration entity via UL MAC CE, RRC, and/or LPP signaling.

In some embodiments, the resources for transmitting such a request indication for an update or allocation of SL Positioning resources may be based on using the existing allocated subset of resources to transmit the Resource re-transmission and re-allocation request provided there are remaining resources available.

In some embodiments, the resources for transmitting such a request indication for an update or allocation of SL Positioning resources may utilize the physical sidelink feedback channel (PSFCH) to transmit a single feedback indication to update and/or re-allocate the resources in the event that a shared resource pool (between SL PRS and SL Data) or SL Data resource pool, is available.

In other embodiments, the resources for transmitting such a request indication for an update or allocation of SL Positioning resources may utilize Mode 2 resource sensing and selection mechanism to transmit such a request indication.

The embodiments of the fifth solution relate to the sensing and selection/allocation of resources within a set of received resources. According to the fifth solution, the configuration UE may transmit a subset of resources out of a totality of received resources from central configuration entity to one or more member UEs, wherein the one or more member UEs may perform sensing and further resource selection/allocation based on the received set of resources from the configuration UE. This is commonly referred to as Mode 2 resource allocation, wherein the UE autonomously determines the SL positioning transmission resources within a given set of received resources or based on a pre-configured set of resources.

In an alternative implementation, the configuration UE may forward the total received resource configuration from the gNB to each of the member UEs. In one implementation, each of the member UEs including the configuration UE may perform sensing and reservation of the total received set of resources and thereafter selection of the resources, while in another implementation, each of the member UEs excluding the configuration UE may perform sensing and reservation of the total received set of resources and thereafter selection of the resources.

Each member UE may receive the following information from the higher layer, e.g., PC5 RRC signaling, a new SL positioning protocol (SLPP/Ranging SL positioning protocol (RSPP) via exemplary messages used to configure SL-PRS configurations or assistance dae.g., e.g., RequestSLPositioningAssistanceData and/or ProvideSLPositioningAssistanceData, in order to perform sensing and reservation of resources within the subset of resources received from the configuration UE.

In certain embodiments, each member UE may receive the resource pool for which the resources are to be e.g., ed, e.g., a resource pool meant for SL PRS transmissions or resource pool meant for SL Data transmissions for the transmission of a measurement report, configuration signaling, error cause signaling, etc.

In certain embodiments, each member UE may receive the L1 priority of the SL positioning message tre.g., ission, e.g., SL PRS may have a higher priority with respect to other SL positioning messages or signals or vice versa. In another implementation, the L1 priority may also indicate the priority of SL positioning signals and messages with respect to other SL signals and data.

In certain embodiments, each member UE may receive SL Positioning QoS related information including the latency of the positioning fix. In certain embodiments, each member UE may receive the number of sub-channels and slots used for the transmission of the SL positioning signals and messages.

In certain embodiments, each member UE may receive a further subset of the subset of resources may be used for re-evaluation and/or pre-emption purposes.

In certain embodiments, each member UE may receive an indication on how the sensing for the SL positioning signals and messages are te.g., performed, e.g., using full sensing (sensing across a 1000 ms interval/window), partial sensing (sensing across 32 slots, which is beneficial for member UEs which are power-limited).

In another implementation, the above information used to perform sensing and reservation of resources may be performed using lower layer signaling such as SL MAC-Ce.g., CI indications, e.g., using flags or bitmaps or bitwise indications.

The configuration UE may also signal the following information to each member UE in addition to the resource configuration, which assists in performing the sensing, reservation and resource selection of the transmission of SL signals and messages within a SL positioning group: A) SL positioning sensing selection window within the bounds [T₁ and T₂]; B) SL positioning sensing window, which may be aligned with the SL PRS configuration, for example; C) SL Received Signal Ste.g., th (RSS) threshold, e.g., RSRP, Received Signal Strength Indicator (RSSI) of the SL positioning signals and messages; D) The type of SL positioning reference signal or other SL refe.g., ce signal to be sensed, e.g., SL PRS; E) A SL positioning reservation periodic list; F) An indication if pre-emption of the reserved SL positioning signals and messages is enabled; or a combination thereof.

The above information may bee.g., naled using UE-specific SL (i.e., PC5) interface using SCI, PC5 RRC, SL positioning protocol signaling. This may further include signaling which may user plane, control plane or combination thereof. Additionally, the common signaling may also be used to signal the aforementioned sensing, reservation and selection information using groupcast, broadcast, e g., SIB, SL PosSIB, PosSIB information signaling.

In another implementation, the configuration UE may further indicate to the member UEs, whether to use sensing, reservation, and selection of the subset of received resources. In another implementation, the central configuration entity may further indicate to the member UEs, whether to use sensing, reservation, and selection of the subset of received resources.

In the above solutions, the SL positioning signals correspond to the aforementioned pose.g., ning-related reference signals, e.g., SL PRS, Uu PRS, or CSI-RS, or SRS, while SL positioning messages refer to messages including assistance data configuration (also SL positioning configuration messages), SL positioning capability messages, SL positioning measurement configuration and reporting messages, error cause messages related to SL positioning or the like.

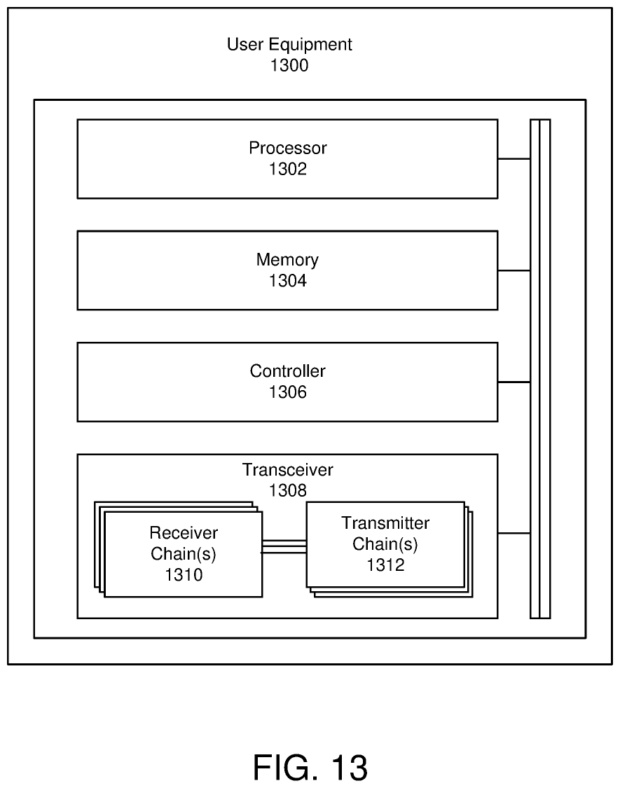

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described he.g., n. These components may be coupled (e.g., operatively, communicatively, functionally, electronically, electrically) via one or more interfaces.

The processor 1302, the memory 1304, the controller 1306, or the transceiver 1308, or various combinations or componee.g., thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a central processing unit (CPU), an ASIC, a field programmable gate array (FPGA), or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to support a means for scheduling, to each member of a SL positioning group, a set of SL positioning time-frequency resources of a plurality of SL positioning time-frequency resources and a means for configuring each member of the SL positioning group with a particular set of SL positioning time-frequency resources.

In some implementations, the scheduling of a respective set of SL positioning time-frequency resources is based on a set of criteria, wherein the set of criteria includes: 1) a positioning technique configured for a respective member of the SL positioning group, 2) a transmission type for the respective member, 3) a transmission priority of the respective member, 4) an availability of an existing allocation to the respective member, or 5) a combination thereof.

In some implementations, a respective set of SL positioning time-frequency resources is scheduled for one-shot SL positioning. In some implementations, a respective set of SL positioning time-frequency resources is scheduled for periodic SL positioning. In some implementations, the UE 1300 may be configured to receive an acknowledgment of receipt of a respective set of SL positioning time-frequency resources from at least one member of the SL positioning group.

In some implementations, a respective set of SL positioning time-frequency resources includes a structure defined by one or more of the following: 1) a series of slots across time domain, 2) a series of subchannels across frequency domain, 3) a SL positioning resource set, 4) a dedicated SL positioning pool, 5) a shared pool for transmission of both SL positioning information and non-positioning SL data, 6) a dedicated SL bandwidth part for SL positioning, 7) a SL positioning frequency layer, or 8) a combination thereof.

In some implementations, to configure each member of the SL positioning group with a particular set of SL positioning time-frequency resources, the UE 1300 may be configured to transmit a configuration for sensing, reservation, and selection, the configuration for sensing, reservation, and selection including: 1) a SL positioning sensing selection window, 2) a SL positioning sensing reselection window, 3) a SL positioning sensing window, 4) a SL Received Signal Strength threshold, 5) a type of reference signal to be sensed, 6) a reservation period list, 7) an indication of whether pre-emption is enabled, or combination thereof.

The UE 1300 may be configured to support a means for transmitting, to a SL positioning group member, an activation command for transmission of at least one SL PRS using a respective scheduled set of SL positioning time-frequency resources and a means for transmitting, to the SL positioning group member, a deactivation command to release the respective scheduled set of SL positioning time-frequency resources.

In some implementations, the UE 1300 may be configured to receive the plurality of SL positioning time-frequency resources from a configuration device. In certain implementations, the configuration device includes: 1) a centralized configuration entity, 2) a base station unit, 3) a location management function, or 4) a RSU.

In some implementations, the UE 1300 includes: 1) an anchor UE, 2) a reference UE, 3) a target-UE, 4) a SL positioning server UE, 5) an assistant UE, 6) a client UE, or a combination thereof. In some implementations, the UE 1300 is a configuration UE within a SL positioning group.

In some implementations, the UE 1300 operates in a different RRC state than a particular member of the SL positioning group, the RRC state being one of: a RRC connected state, a RRC inactive state, or a RRC idle state.

In some implementations, the UE 1300 may be configured to receive a resource request from a particular member of the SL positioning group, the resource request including one of: A) an initial request for transmission of a subset of SL positioning time-frequency resources, B) a request for re-transmission of a subset of SL positioning time-frequency resources, C) a request for additional SL positioning time-frequency resources, or D) a request for re-allocation of SL positioning time-frequency resources previously allocated to the particular member of the SL positioning group.

In certain implementations, the resource request is received on a subset of SL positioning time-frequency resources previously allocated to the particular member of the SL positioning group. In certain implementations, the resource request is received on a PSFCH.

In some implementations, the UE 1300 may be configured to transmit, to at least one member of the SL positioning group, a selection indication specifying whether the at least one member is to perform autonomous resource allocation of a subset of the configured set of SL positioning time-frequency resources. In certain implementations, the configured set of SL positioning time-frequency resources includes a totality of the plurality of SL positioning time-frequency resources.

In certain implementations, the UE 1300 may be configured to transmit, to each member of the SL positioning group, sensing-and-reservation information including: 1) resource pool information for SL PRS transmission, 2) resource pool information for SL positioning message transmission, 3) a layer-1 priority for SL PRS signals, 4) a layer-1 priority for SL positioning messages, 5) a SL positioning QoS, 6) a number of subchannels, 7) a portion of the subset reserved for re-evaluation, 8) a portion of the subset reserved for pre-emption, 9) an indication of the type of sensing to be performed, or combination thereof.

In certain implementations, each member of the SL positioning group is configured with a higher-layer trigger including the sensing-and-reservation information. In certain implementations, to transmit the sensing-and-reservation information, the UE 1300 may be configured to send lower-layer signaling to each member.

In some implementations, one or more SL positioning messages are signaled via lower-layer signaling, or higher-layer signaling, or a combination thereof, based on a transmitting entity. In such implementations, the lower-layer signaling includes at least one of: UCI, DCI, SCI, uplink MAC CE, downlink MAC CE, sidelink MAC CE, or Radio Resource Control signaling. Further, the higher-layer signaling includes at least one of a SL positioning protocol message, a LPP message, or a combination thereof.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to support a means for receiving, from a configuration device, a positioning configuration that schedules a set of SL positioning time-frequency resources of a plurality of SL positioning time-frequency resources and a means for receiving, from the configuration device, an activation command for the scheduled set of SL positioning time-frequency resources.

In some embodiments, the configuration device includes: 1) an anchor UE, 2) a reference UE, 3) a target-UE, 4) a SL positioning server UE, 5) an assistant UE, 6) a client UE, or a combination thereof. In some embodiments, the configuration device includes a base station unit or a configuration UE.

In some embodiments, the set of SL positioning time-frequency resources is scheduled for one-shot SL positioning. In some embodiments, the set of SL positioning time-frequency resources is scheduled for periodic SL positioning. In some embodiments, the UE 1300 may be configured to transmit, to the configuration device, an acknowledgment of receipt of the set of SL positioning time-frequency resources.

In some embodiments, the set of SL positioning time-frequency resources includes a structure defined by one or more of the following: 1) a series of slots across time domain, 2) a series of subchannels across frequency domain, 3) a SL positioning resource set, 4) a dedicated SL positioning pool, 5) a shared pool for transmission of both SL positioning information and non-positioning SL data, 6) a dedicated SL bandwidth part for SL positioning, 7) a SL positioning frequency layer, or a combination thereof.

In some embodiments, the second apparatus operates in a different RRC state than the configuration device, the RRC state being one of: a RRC connected state, a RRC inactive state, or a RRC idle state.

The UE 1300 may be configured to support a means for performing a SL positioning procedure using the scheduled set of SL positioning time-frequency resources, where the SL positioning procedure includes: transmitting a SL PRS, measuring a SL PRS transmission, reporting a SL positioning measurement, or a combination thereof. The UE 1300 may also be configured to support a means for receiving, from the configuration device, a deactivation command to release the respective scheduled set of SL positioning time-frequency resources.

In some embodiments, the UE 1300 may be configured to transmit, to the configuration device, a resource request in response to detecting a trigger condition, the resource request including one of: A) an initial request for transmission of a subset of SL positioning time-frequency resources, B) a request for re-transmission of a subset of SL positioning time-frequency resources, C) a request for additional SL positioning time-frequency resources, or D) a request for re-allocation of the scheduled set of SL positioning time-frequency resources.

In certain embodiments, the resource request is transmitted on a subset of scheduled set of SL positioning time-frequency resources. In certain embodiments, the resource request is transmitted on a PSFCH.

In some embodiments, the trigger condition includes: A) determining that the scheduled set of SL positioning time-frequency resources is insufficient for a particular SL positioning technique, B) determining a change of SL positioning QoS, C) determining a change of SL positioning technique, D) determining a change of coverage scenario, E) determining an update of pre-configured resources for SL positioning, or a combination thereof.

In some embodiments, the UE 1300 may be configured to receive, from the configuration device, a selection indication specifying whether to perform autonomous resource allocation of a subset of the configured set of SL positioning time-frequency resources. In some embodiments, the positioning configuration further includes: 1) a SL positioning sensing selection window, 2) a SL positioning sensing reselection window, 3) a SL positioning sensing window, 4) a SL Received Signal Strength threshold, 5) a type of reference signal to be sensed, 6) a reservation period list, 7) an indication of whether pre-emption is enabled, or combination thereof.

In certain embodiments, the UE 1300 may be configured to receive, from the configuration device, sensing-and-reservation information including: 1) resource pool information for SL PRS transmission, 2) resource pool information for SL positioning message transmission, 3) a layer-1 priority for SL PRS signals, 4) a layer-1 priority for SL positioning messages, 5) a SL positioning QoS, 6) a number of subchannels, 7) a portion of the subset reserved for re-evaluation, 8) a portion of the subset reserved for pre-emption, 9) an indication of the type of sensing to be performed, or combination thereof.

In certain embodiments, to receive the sensing-and-reservation information, the UE 1300 may be configured to receive a higher-layer trigger including the sensing-and-reservation information. In certain embodiments, to receive the sensing-and-reservation information, the UE 1300 may be configured to receive lower-layer signaling.

In some embodiments, one or more SL positioning messages are signaled via lower-layer signaling, or higher-layer signaling, or a combination thereof, based on a transmitting entity. In such embodiments, the lower-layer signaling includes at least one of: UCI, DCI, SCI, uplink MAC CE, downlink MAC CE, sidelink MAC CE, or Radio Resource Control signaling. Further, the higher-layer signaling includes at least one of a SL positioning protocol message, a LPP message, or a combination thereof.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receiving the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receiving signal and obtain the transmitted data by reversing the modulation technique applied during transmission of the signal. The receiver chain 1310 may include at least one decoder for decoding and processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

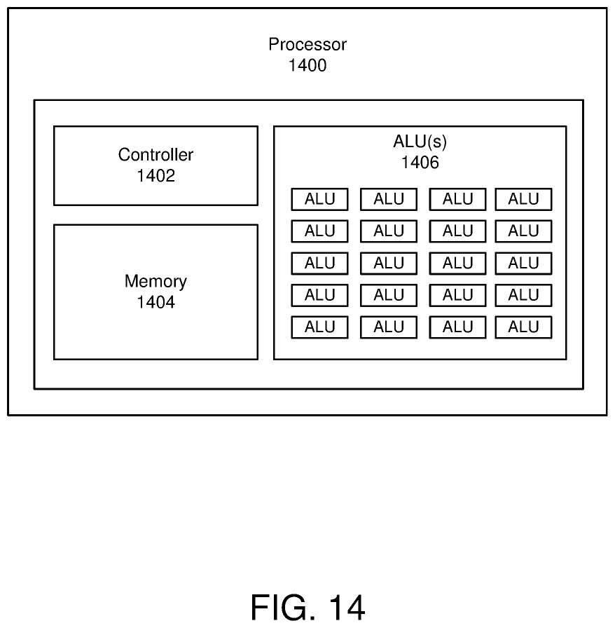

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory address of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, arithmetic logic units (ALUs), and other functional units of the processor 1400.

The memory 1404 may include one or more caches (e.g., memory local to or included in the processor 1400 or other memory, such RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, the controller 1402, and the memory 1404 may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support a means for scheduling, to each member of a SL positioning group, a set of SL positioning time-frequency resources of a plurality of SL positioning time-frequency resources and a means for configuring each member of the SL positioning group with a particular set of SL positioning time-frequency resources.

In some implementations, the scheduling of a respective set of SL positioning time-frequency resources is based on a set of criteria, wherein the set of criteria includes: 1) a positioning technique configured for a respective member of the SL positioning group, 2) a transmission type for the respective member, 3) a transmission priority of the respective member, 4) an availability of an existing allocation to the respective member, or 5) a combination thereof.

In some implementations, a respective set of SL positioning time-frequency resources is scheduled for one-shot SL positioning. In some implementations, a respective set of SL positioning time-frequency resources is scheduled for periodic SL positioning. In some implementations, the processor 1400 may be configured to receive an acknowledgment of receipt of a respective set of SL positioning time-frequency resources from at least one member of the SL positioning group.

In some implementations, a respective set of SL positioning time-frequency resources includes a structure defined by one or more of the following: 1) a series of slots across time domain, 2) a series of subchannels across frequency domain, 3) a SL positioning resource set, 4) a dedicated SL positioning pool, 5) a shared pool for transmission of both SL positioning information and non-positioning SL data, 6) a dedicated SL bandwidth part for SL positioning, 7) a SL positioning frequency layer, or 8) a combination thereof.

In some implementations, to configure each member of the SL positioning group with a particular set of SL positioning time-frequency resources, the processor 1400 may be configured to transmit a configuration for sensing, reservation, and selection, the configuration for sensing, reservation, and selection including: 1) a SL positioning sensing selection window, 2) a SL positioning sensing reselection window, 3) a SL positioning sensing window, 4) a SL Received Signal Strength threshold, 5) a type of reference signal to be sensed, 6) a reservation period list, 7) an indication of whether pre-emption is enabled, or combination thereof.

The processor 1400 may be configured to support a means for transmitting, to a SL positioning group member, an activation command for transmission of at least one SL PRS using a respective scheduled set of SL positioning time-frequency resources and a means for transmitting, to the SL positioning group member, a deactivation command to release the respective scheduled set of SL positioning time-frequency resources.

In some implementations, the processor 1400 may be configured to receive the plurality of SL positioning time-frequency resources from a configuration device. In certain implementations, the configuration device includes: 1) a centralized configuration entity, 2) a base station unit, 3) a location management function, or 4) a RSU.

In some implementations, the processor 1400 includes: 1) an anchor UE, 2) a reference UE, 3) a target-UE, 4) a SL positioning server UE, 5) an assistant UE, 6) a client UE, or a combination thereof. In some implementations, the processor 1400 is a configuration UE within a SL positioning group.

In some implementations, the processor 1400 operates in a different RRC state than a particular member of the SL positioning group, the RRC state being one of: a RRC connected state, a RRC inactive state, or a RRC idle state.

In some implementations, the processor 1400 may be configured to receive a resource request from a particular member of the SL positioning group, the resource request including one of: A) an initial request for transmission of a subset of SL positioning time-frequency resources, B) a request for re-transmission of a subset of SL positioning time-frequency resources, C) a request for additional SL positioning time-frequency resources, or D) a request for re-allocation of SL positioning time-frequency resources previously allocated to the particular member of the SL positioning group.

In certain implementations, the resource request is received on a subset of SL positioning time-frequency resources previously allocated to the particular member of the SL positioning group. In certain implementations, the resource request is received on a PSFCH.

In some implementations, the processor 1400 may be configured to transmit, to at least one member of the SL positioning group, a selection indication specifying whether the at least one member is to perform autonomous resource allocation of a subset of the configured set of SL positioning time-frequency resources. In certain implementations, the configured set of SL positioning time-frequency resources includes a totality of the plurality of SL positioning time-frequency resources.

In certain implementations, the processor 1400 may be configured to transmit, to each member of the SL positioning group, sensing-and-reservation information including: 1) resource pool information for SL PRS transmission, 2) resource pool information for SL positioning message transmission, 3) a layer-1 priority for SL PRS signals, 4) a layer-1 priority for SL positioning messages, 5) a SL positioning QoS, 6) a number of subchannels, 7) a portion of the subset reserved for re-evaluation, 8) a portion of the subset reserved for pre-emption, 9) an indication of the type of sensing to be performed, or combination thereof.

In certain implementations, each member of the SL positioning group is configured with a higher-layer trigger including the sensing-and-reservation information. In certain implementations, to transmit the sensing-and-reservation information, the processor 1400 may be configured to send lower-layer signaling to each member.

In some implementations, one or more SL positioning messages are signaled via lower-layer signaling, or higher-layer signaling, or a combination thereof, based on a transmitting entity. In such implementations, the lower-layer signaling includes at least one of: UCI, DCI, SCI, uplink MAC CE, downlink MAC CE, sidelink MAC CE, or Radio Resource Control signaling. Further, the higher-layer signaling includes at least one of a SL positioning protocol message, a LPP message, or a combination thereof.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to support a means for receiving, from a configuration device, a positioning configuration that schedules a set of SL positioning time-frequency resources of a plurality of SL positioning time-frequency resources and a means for receiving, from the configuration device, an activation command for the scheduled set of SL positioning time-frequency resources.

In some embodiments, the configuration device includes: 1) an anchor UE, 2) a reference UE, 3) a target-UE, 4) a SL positioning server UE, 5) an assistant UE, 6) a client UE, or a combination thereof. In some embodiments, the configuration device includes a base station unit or a configuration UE.

In some embodiments, the set of SL positioning time-frequency resources is scheduled for one-shot SL positioning. In some embodiments, the set of SL positioning time-frequency resources is scheduled for periodic SL positioning. In some embodiments, the UE 1300 may be configured to transmit, to the configuration device, an acknowledgment of receipt of the set of SL positioning time-frequency resources.

In some embodiments, the set of SL positioning time-frequency resources includes a structure defined by one or more of the following: 1) a series of slots across time domain, 2) a series of subchannels across frequency domain, 3) a SL positioning resource set, 4) a dedicated SL positioning pool, 5) a shared pool for transmission of both SL positioning information and non-positioning SL data, 6) a dedicated SL bandwidth part for SL positioning, 7) a SL positioning frequency layer, or a combination thereof.

In some embodiments, the second apparatus operates in a different RRC state than the configuration device, the RRC state being one of: a RRC connected state, a RRC inactive state, or a RRC idle state.

The UE 1300 may be configured to support a means for performing a SL positioning procedure using the scheduled set of SL positioning time-frequency resources, where the SL positioning procedure includes: transmitting a SL PRS, measuring a SL PRS transmission, reporting a SL positioning measurement, or a combination thereof. The UE 1300 may also be configured to support a means for receiving, from the configuration device, a deactivation command to release the respective scheduled set of SL positioning time-frequency resources.

In some embodiments, the UE 1300 may be configured to transmit, to the configuration device, a resource request in response to detecting a trigger condition, the resource request including one of: A) an initial request for transmission of a subset of SL positioning time-frequency resources, B) a request for re-transmission of a subset of SL positioning time-frequency resources, C) a request for additional SL positioning time-frequency resources, or D) a request for re-allocation of the scheduled set of SL positioning time-frequency resources.

In certain embodiments, the resource request is transmitted on a subset of scheduled set of SL positioning time-frequency resources. In certain embodiments, the resource request is transmitted on a PSFCH.

In some embodiments, the trigger condition includes: A) determining that the scheduled set of SL positioning time-frequency resources is insufficient for a particular SL positioning technique, B) determining a change of SL positioning QoS, C) determining a change of SL positioning technique, D) determining a change of coverage scenario, E) determining an update of pre-configured resources for SL positioning, or a combination thereof.

In some embodiments, the UE 1300 may be configured to receive, from the configuration device, a selection indication specifying whether to perform autonomous resource allocation of a subset of the configured set of SL positioning time-frequency resources. In some embodiments, the positioning configuration further includes: 1) a SL positioning sensing selection window, 2) a SL positioning sensing reselection window, 3) a SL positioning sensing window, 4) a SL Received Signal Strength threshold, 5) a type of reference signal to be sensed, 6) a reservation period list, 7) an indication of whether pre-emption is enabled, or combination thereof.

In certain embodiments, the UE 1300 may be configured to receive, from the configuration device, sensing-and-reservation information including: 1) resource pool information for SL PRS transmission, 2) resource pool information for SL positioning message transmission, 3) a layer-1 priority for SL PRS signals, 4) a layer-1 priority for SL positioning messages, 5) a SL positioning QoS, 6) a number of subchannels, 7) a portion of the subset reserved for re-evaluation, 8) a portion of the subset reserved for pre-emption, 9) an indication of the type of sensing to be performed, or combination thereof.

In certain embodiments, to receive the sensing-and-reservation information, the UE 1300 may be configured to receive a higher-layer trigger including the sensing-and-reservation information. In certain embodiments, to receive the sensing-and-reservation information, the UE 1300 may be configured to receive lower-layer signaling.

In some embodiments, one or more SL positioning messages are signaled via lower-layer signaling, or higher-layer signaling, or a combination thereof, based on a transmitting entity. In such embodiments, the lower-layer signaling includes at least one of: UCI, DCI, SCI, uplink MAC CE, downlink MAC CE, sidelink MAC CE, or Radio Resource Control signaling. Further, the higher-layer signaling includes at least one of a SL positioning protocol message, a LPP message, or a combination thereof.

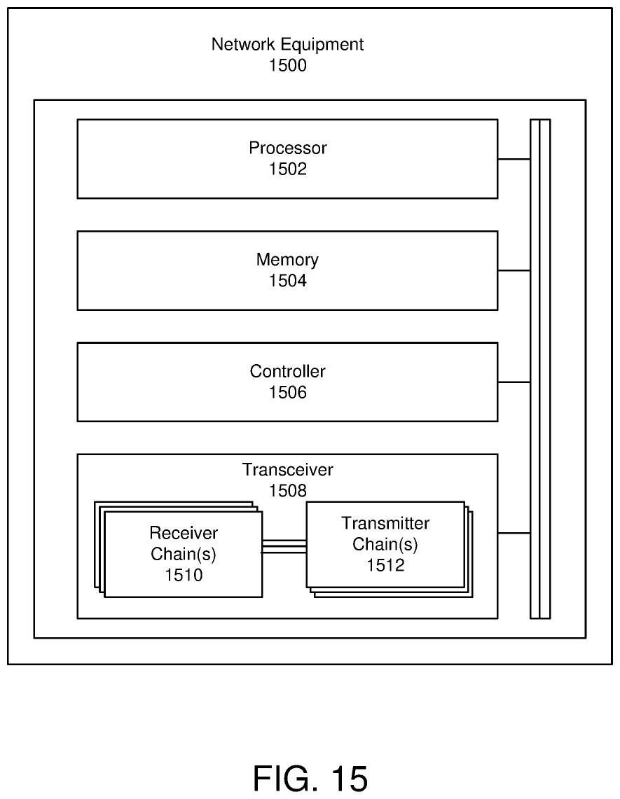

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein. The NE 1500 may be configured to support a means for scheduling, to each member of a SL positioning group, a set of SL positioning time-frequency resources of a plurality of SL positioning time-frequency resources and a means for configuring each member of the SL positioning group with a particular set of SL positioning time-frequency resources.

In some implementations, the scheduling of a respective set of SL positioning time-frequency resources is based on a set of criteria, wherein the set of criteria includes: 1) a positioning technique configured for a respective member of the SL positioning group, 2) a transmission type for the respective member, 3) a transmission priority of the respective member, 4) an availability of an existing allocation to the respective member, or 5) a combination thereof.

In some implementations, a respective set of SL positioning time-frequency resources is scheduled for one-shot SL positioning. In some implementations, a respective set of SL positioning time-frequency resources is scheduled for periodic SL positioning. In some implementations, the NE 1500 may be configured to receive an acknowledgment of receipt of a respective set of SL positioning time-frequency resources from at least one member of the SL positioning group.

In some implementations, a respective set of SL positioning time-frequency resources includes a structure defined by one or more of the following: 1) a series of slots across time domain, 2) a series of subchannels across frequency domain, 3) a SL positioning resource set, 4) a dedicated SL positioning pool, 5) a shared pool for transmission of both SL positioning information and non-positioning SL data, 6) a dedicated SL bandwidth part for SL positioning, 7) a SL positioning frequency layer, or 8) a combination thereof.

In some implementations, to configure each member of the SL positioning group with a particular set of SL positioning time-frequency resources, the NE 1500 may be configured to transmit a configuration for sensing, reservation, and selection, the configuration for sensing, reservation, and selection including: 1) a SL positioning sensing selection window, 2) a SL positioning sensing reselection window, 3) a SL positioning sensing window, 4) a SL Received Signal Strength threshold, 5) a type of reference signal to be sensed, 6) a reservation period list, 7) an indication of whether pre-emption is enabled, or combination thereof.

The NE 1500 may be configured to support a means for transmitting, to a SL positioning group member, an activation command for transmission of at least one SL PRS using a respective scheduled set of SL positioning time-frequency resources and a means for transmitting, to the SL positioning group member, a deactivation command to release the respective scheduled set of SL positioning time-frequency resources.

In some implementations, the NE 1500 may be configured to receive the plurality of SL positioning time-frequency resources from a configuration device. In certain implementations, the configuration device includes: 1) a centralized configuration entity, 2) a configuration UE, 3) a location management function, or 4) a RSU. In some implementations, the NE 1500 is a base station unit.

In some implementations, the NE 1500 operates in a different RRC state than a particular member of the SL positioning group, the RRC state being one of: a RRC connected state, a RRC inactive state, or a RRC idle state.

In some implementations, the NE 1500 may be configured to receive a resource request from a particular member of the SL positioning group, the resource request including one of: A) an initial request for transmission of a subset of SL positioning time-frequency resources, B) a request for re-transmission of a subset of SL positioning time-frequency resources, C) a request for additional SL positioning time-frequency resources, or D) a request for re-allocation of SL positioning time-frequency resources previously allocated to the particular member of the SL positioning group.

In certain implementations, the resource request is received on a subset of SL positioning time-frequency resources previously allocated to the particular member of the SL positioning group. In certain implementations, the resource request is received on a PSFCH.

In some implementations, the NE 1500 may be configured to transmit, to at least one member of the SL positioning group, a selection indication specifying whether the at least one member is to perform autonomous resource allocation of a subset of the configured set of SL positioning time-frequency resources. In certain implementations, the configured set of SL positioning time-frequency resources includes a totality of the plurality of SL positioning time-frequency resources.

In certain implementations, the NE 1500 may be configured to transmit, to each member of the SL positioning group, sensing-and-reservation information including: 1) resource pool information for SL PRS transmission, 2) resource pool information for SL positioning message transmission, 3) a layer-1 priority for SL PRS signals, 4) a layer-1 priority for SL positioning messages, 5) a SL positioning QoS, 6) a number of subchannels, 7) a portion of the subset reserved for re-evaluation, 8) a portion of the subset reserved for pre-emption, 9) an indication of the type of sensing to be performed, or combination thereof.

In certain implementations, each member of the SL positioning group is configured with a higher-layer trigger including the sensing-and-reservation information. In certain implementations, to transmit the sensing-and-reservation information, the NE 1500 may be configured to send lower-layer signaling to each member.

In some implementations, one or more SL positioning messages are signaled via lower-layer signaling, or higher-layer signaling, or a combination thereof, based on a transmitting entity. In such implementations, the lower-layer signaling includes at least one of UCI, DCI, SCI, uplink MAC CE, downlink MAC CE, sidelink MAC CE, or Radio Resource Control signaling. Further, the higher-layer signaling includes at least one of a SL positioning protocol message, a LPP message, or a combination thereof.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas for receiving the signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receiving signal and obtain the transmitted data by reversing the modulation technique applied during transmission of the signal. The receiver chain 1510 may include at least one decoder for decoding and processing the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

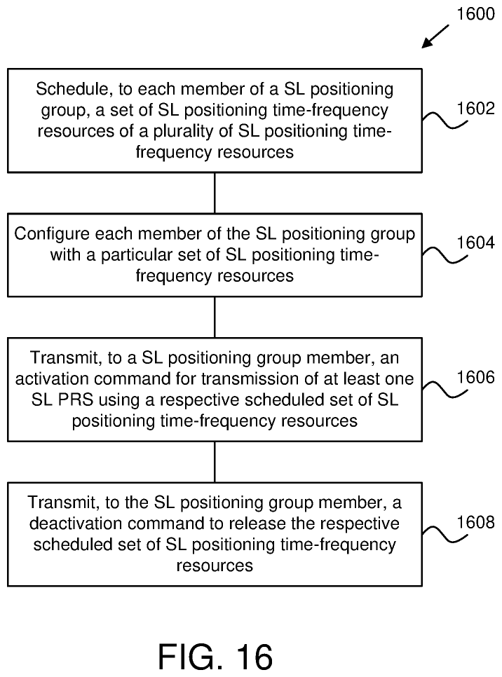

FIG. 16 illustrates a flowchart of a method 1600 in accordance with aspects of the present disclosure. The operations of the method 1600 may be implemented by a UE as described herein. In some implementations, the UE may execute a set of instructions to control the function elements of the UE to perform the described functions.

At Step 1602, the method 1600 may include scheduling, to each member of a SL positioning group, a set of SL positioning time-frequency resources of a plurality of SL positioning time-frequency resources. The operations of Step 1602 may be performed in accordance with examples as described herein. In some implementations, aspects of the operations of Step 1602 may be performed by a UE as described with reference to FIG. 13.

At Step 1604, the method 1600 may include configuring each member of the SL positioning group with a particular set of SL positioning time-frequency resources. The operations of Step 1604 may be performed in accordance with examples as described herein. In some implementations, aspects of the operations of Step 1604 may be performed by a UE as described with reference to FIG. 13.

At Step 1606, the method 1600 may include transmitting, to a SL positioning group member, an activation command for transmission of at least one SL PRS using a respective scheduled set of SL positioning time-frequency resources. The operations of Step 1606 may be performed in accordance with examples as described herein. In some implementations, aspects of the operations of Step 1606 may be performed a UE as described with reference to FIG. 13.

At Step 1608, the method 1600 may include transmitting, to the SL positioning group member, a deactivation command to release the respective scheduled set of SL positioning time-frequency resources. The operations of Step 1608 may be performed in accordance with examples as described herein. In some implementations, aspects of the operations of Step 1608 may be performed a UE as described with reference to FIG. 13.

It should be noted that the method 1600 described herein describes one possible implementation, and that the operations and the steps may be rearranged or otherwise modified and that other implementations are possible.

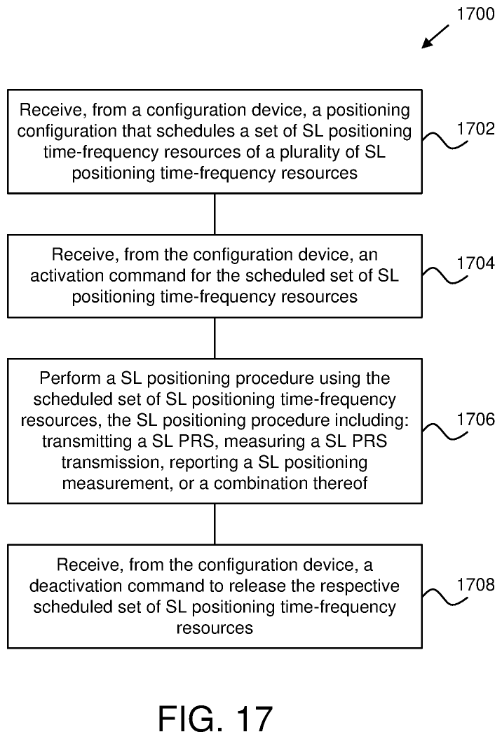

FIG. 17 illustrates a flowchart of a method 1700 in accordance with aspects of the present disclosure. The operations of the method 1700 may be implemented by a NE as described herein. In some implementations, the NE may execute a set of instructions to control the function elements of the NE to perform the described functions.

At Step 1702, the method 1700 may include receiving, from a configuration device, a positioning configuration that schedules a set of SL positioning time-frequency resources of a plurality of SL positioning time-frequency resources. The operations of Step 1702 may be performed in accordance with examples as described herein. In some implementations, aspects of the operations of Step 1702 may be performed by a UE as described with reference to FIG. 13.

At Step 1704, the method 1700 may include receiving, from the configuration device, an activation command for the scheduled set of SL positioning time-frequency resources. The operations of Step 1704 may be performed in accordance with examples as described herein. In some implementations, aspects of the operations of Step 1704 may be performed by a UE as described with reference to FIG. 13.

At Step 1706, the method 1700 may include performing a SL positioning procedure using the scheduled set of SL positioning time-frequency resources, the SL positioning procedure including: transmitting a SL PRS, measuring a SL PRS transmission, reporting a SL positioning measurement, or a combination thereof. The operations of Step 1706 may be performed in accordance with examples as described herein. In some implementations, aspects of the operations of Step 1706 may be performed a UE as described with reference to FIG. 13.

At Step 1708, the method 1700 may include receiving, from the configuration device, a deactivation command to release the respective scheduled set of SL positioning time-frequency resources. The operations of Step 1708 may be performed in accordance with examples as described herein. In some implementations, aspects of the operations of Step 1708 may be performed a UE as described with reference to FIG. 13.

It should be noted that the method 1700 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
schedule, to each member of a sidelink (SL) positioning group, a set of SL positioning time-frequency resources of a plurality of SL positioning time-frequency resources;
configure each member of the SL positioning group with a particular set of SL positioning time-frequency resources;
transmit, to a SL positioning group member, an activation command for transmission of at least one SL positioning reference signal (PRS) using a respective scheduled set of SL positioning time-frequency resources; and
transmit, to the SL positioning group member, a deactivation command to release the respective scheduled set of SL positioning time-frequency resources.

2. The UE of claim 1, wherein the at least one processor is further configured to cause the UE to receive the plurality of SL positioning time-frequency resources from a configuration device, wherein the configuration device comprises:
a centralized configuration entity,
a base station unit,
a location management function,
a road side unit (RSU),
or a combination thereof.

3. The UE of claim 1, wherein the UE comprises:
an anchor UE,
a reference UE,
a target-UE,
a SL positioning server UE,
an assistant UE,
a client UE,
a configuration UE within a SL positioning group,
or a combination thereof.

4. The UE of claim 1, wherein the scheduling of a respective set of SL positioning time-frequency resources is based on a set of criteria, wherein the set of criteria comprises:
a positioning technique configured for a respective member of the SL positioning group,
a transmission type for the respective member,
a transmission priority of the respective member,
an availability of an existing allocation to the respective member,
or a combination thereof.

5. The UE of claim 1, wherein a respective set of SL positioning time-frequency resources is scheduled for one of: periodic SL positioning or one-shot SL positioning.

6. The UE of claim 1, wherein the at least one processor is further configured to cause the UE to receive an acknowledgment of receipt of a respective set of SL positioning time-frequency resources from at least one member of the SL positioning group.

7. The UE of claim 1, wherein a respective set of SL positioning time-frequency resources comprises a structure defined by one or more of the following:
a series of slots across time domain,
a series of subchannels across frequency domain,
a SL positioning resource set,
a dedicated SL positioning pool,
a shared pool for transmission of both SL positioning information and non-positioning SL data,
a dedicated SL bandwidth part for SL positioning,
a SL positioning frequency layer,
or a combination thereof.

8. The UE of claim 1, wherein the at least one processor is further configured to cause the UE to operate in a different radio resource control (RRC) state than a particular member of the SL positioning group, the RRC state being one of:
a RRC connected state,
a RRC inactive state, or
a RRC idle state.

9. The UE of claim 1, wherein the at least one processor is further configured to cause the UE to transmit, to at least one member of the SL positioning group, a selection indication specifying whether the at least one member is to perform autonomous resource allocation of a subset of the configured set of SL positioning time-frequency resources.

10. The UE of claim 9, wherein the configured set of SL positioning time-frequency resources comprises a totality of the plurality of SL positioning time-frequency resources.

11. The UE of claim 9, wherein the at least one processor is further configured to cause the UE to transmit, to each member of the SL positioning group, sensing-and-reservation information comprising:
resource pool information for SL PRS transmission,
resource pool information for SL positioning message transmission,
a layer-1 priority for SL PRS signals,
a layer-1 priority for SL positioning messages,
a SL positioning Quality of Service (QoS),
a number of subchannels,
a portion of the subset reserved for re-evaluation,
a portion of the subset reserved for pre-emption,
an indication of the type of sensing to be performed or combination thereof.

12. The UE of claim 11, wherein each member of the SL positioning group is configured with a higher-layer trigger comprising the sensing-and-reservation information.

13. The UE of claim 11, wherein to transmit the sensing-and-reservation information, the at least one processor is configured to cause the UE to send lower-layer signaling to each member.

14. The UE of claim 9, wherein to configure each member of the SL positioning group with a particular set of SL positioning time-frequency resources, the at least one processor is further configured to cause the UE to transmit a configuration for sensing, reservation, and selection comprising:
a SL positioning sensing selection window,
a SL positioning sensing reselection window,
a SL positioning sensing window,
a SL Received Signal Strength threshold,
a type of reference signal to be sensed,
a reservation period list,
an indication of whether pre-emption is enabled,
or combination thereof.

15. The UE of claim 1,
wherein one or more SL positioning messages are signaled via lower-layer signaling, or higher-layer signaling, or a combination thereof, based on a transmitting entity,
wherein the lower-layer signaling comprises at least one of: uplink control information (UCI), downlink control information (DCI), sidelink control information (SCI), uplink Medium Access Control (MAC) Control Element (CE), downlink MAC CE, sidelink MAC CE, or Radio Resource Control (RRC) signaling, and
wherein the higher-layer signaling comprises at least one of a SL positioning protocol message, a Long-Term Evolution (LTE) positioning protocol (LPP) message, or a combination thereof.

16. A method performed by a User Equipment (UE), the method comprising:
scheduling, to each member of a sidelink (SL) positioning group, a set of SL positioning time-frequency resources of a plurality of SL positioning time-frequency resources;
configuring each member of the SL positioning group with a particular set of SL positioning time-frequency resources;
transmitting, to a SL positioning group member, an activation command for transmission of at least one SL positioning reference signal (PRS) using a respective scheduled set of SL positioning time-frequency resources; and
transmitting, to the SL positioning group member, a deactivation command to release the respective scheduled set of SL positioning time-frequency resources.

17. A User Equipment (UE) for wireless communication, comprising:
at least one memory; and
at least one processor coupled with the at least one memory and configured to cause the UE to:
receive, from a configuration device, a positioning configuration that schedules a set of sidelink (SL) positioning time-frequency resources of a plurality of SL positioning time-frequency resources;
receive, from the configuration device, an activation command for the scheduled set of SL positioning time-frequency resources; and
perform a SL positioning procedure using the scheduled set of SL positioning time-frequency resources, the SL positioning procedure comprising:
transmitting a SL Positioning Reference Signal (PRS),
measuring a SL PRS transmission,
reporting a SL positioning measurement,
or a combination thereof;
receive, from the configuration device, a deactivation command to release the respective scheduled set of SL positioning time-frequency resources.

18. The UE of claim 17, wherein the at least one processor is further configured to cause the UE to transmit, to the configuration device, a resource request in response to detecting a trigger condition, wherein the resource request is transmitted on a subset of scheduled set of SL positioning time-frequency resources, or on a Physical Sidelink Feedback Channel PSFCH).

19. The UE of claim 18, wherein the trigger condition comprises:
determining that the scheduled set of SL positioning time-frequency resources is insufficient for a particular SL positioning technique,
determining a change of SL positioning Quality of Service (QoS),
determining a change of SL positioning technique,
determining a change of coverage scenario,
determining an update of pre-configured resources for SL positioning,
or a combination thereof.

20. A method performed by a User Equipment (UE), the method comprising:
receiving, from a configuration device, a positioning configuration that schedules a set of sidelink (SL) positioning time-frequency resources of a plurality of SL positioning time-frequency resources;
receiving, from the configuration device, an activation command for the scheduled set of SL positioning time-frequency resources; and
performing a SL positioning procedure using the scheduled set of SL positioning time-frequency resources, the SL positioning procedure comprising:
transmitting a SL Positioning Reference Signal (PRS),
measuring a SL PRS transmission,
reporting a SL positioning measurement,
or a combination thereof;
receiving, from the configuration device, a deactivation command to release the respective scheduled set of SL positioning time-frequency resources.
